(19) United States
(12) Patent Application Publication
(10) Pub. No.: US 2024/0134300 A1
(43) Pub. Date: Apr. 25, 2024

(54) TONER

(71) Applicant: CANON KABUSHIKI KAISHA, Tokyo (JP)

(72) Inventors: HITOSHI SANO, Chiba (JP); SHIN KITAMURA, Ibaraki (JP); TORU TAKAHASHI, Ibaraki (JP); RYUICHIRO MATSUO, Ibaraki (JP); RYUJI MURAYAMA, Chiba (JP); TAKAKUNI KOBORI, Ibaraki (JP); YOSHIHIRO OGAWA, Ibaraki (JP)

(21) Appl. No.: 18/479,680

(22) Filed: Oct. 2, 2023

(30) Foreign Application Priority Data
Oct. 4, 2022 (JP) 2022-159986

(51) Int. Cl. G03G 9/097; G03G 9/08; G03G 9/087

(52) U.S. Cl. CPC G03G 9/09725; G03G 9/0819; G03G 9/08759

(57) ABSTRACT

Provided is a toner comprising a toner particle comprising a binder resin and a. silica fine particle, wherein a total content of a polyvalent metal elements in the toner particle is 0.10 to 2.50 μmol/g, a number-average particle diameter of a primary particle of the silica fine particle is 40 to 500 nm, and in the DD/MAS measurement of solid ²⁹Si-NMR of the silica fine particle, peak PD1 corresponding to a silicon atom represented by Si^{a} in a structure represented by formula (1) and peak PD2 corresponding to a silicon atom represented by Si^{b} in a structure represented by formula (2) are observed, and when an area of the peak PD1 is defined as SD1 and an area of the peak PD2 is defined as SD2, SD1 and SD2 satisfy: 1.2≤(SD1+SD2)/SD1≤10.0.

### BACKGROUND

### Field of the Disclosure

The present disclosure relates to a toner used in electrophotography systems, an electrostatic recording system, an electrostatic printing system, and a toner jet system.

### Description of the Related Art

In recent years, electrophotographic full-color copiers have become widely available, and their application to the print-on-demand (POD) field has begun. In the POD field, high speed, high image quality, and high productivity are required while supporting a wide range of media (paper types). For example, even if the paper type is changed from cardboard to thin paper, media isokinetic, which allows printing to continue without changing the process speed or the heat setting temperature of the fixer according to the paper type, is required. From the viewpoint of media isokinetic, toner is required to properly complete fixing over a wide range of fixing temperatures from low to high. Japanese Patent Application Laid-Open No. 2012-063559 proposes a toner in which a crystalline resin with sharp melt properties is added to the toner to improve low-temperature fixing performance in order to fix at a wide range of fixable temperatures.

On the other hand, in book making or package printing, when a medium such as coated paper on which toner is difficult to fix is used, the printed toner peels off due to strong external stress such as contact with human nails or sharp objects, causing image defects. So-called scratch scraping (scratch peeling) may occur.

As a countermeasure, when printing on a medium such as coated paper, the process speed is reduced to melt the toner sufficiently and fix it firmly on the medium.

Japanese Patent Application Laid-Open No. 2012-63559 does not discuss scratch scraping. Therefore, if a medium such as coated paper where toner is difficult to fix is used, and strong external stress is applied, the fixed toner image is cracked and peeled off.

Therefore, there is still a problem to prevent a scratch scraping even when strong external stress is applied when a medium such as coated paper where toner is difficult to fix is used.

### SUMMARY

The present disclosure provides a toner with high hot offset resistance and high environmental stability required in the POD field, which suppresses the occurrence of scratch scraping even when strong external stress is applied when a medium such as coated paper where toner is difficult to fix is used.

As a result of careful study, the present inventors found that by using the configuration of the present disclosure, the occurrence of scratch scraping is suppressed even when strong external stress is applied when a medium such as coated paper where toner is difficult to fix is used, and it is possible to provide toilers with high hot offset resistance and high environmental stability required in the POD field.

That is, the present disclosure is a toner comprising a toner particle comprising a binder resin, and a silica fine particle,
wherein the toner particle comprises at least one polyvalent metal element selected from the group consisting of aluminum, iron, zinc, magnesium and calcium,
a total content of the polyvalent metal elements in the toner particle, as measured by inductively coupled plasma atomic emission spectroscopy (ICP-AES), is 0.10 to 2.50 μmol/g,
a number-average particle diameter of a primary particle of the silica fine particle is 40 nm to 500 nm, and
in DD/MAS measurement of solid ²⁹Si-NMR of the silica fine particle, peak PD1 corresponding to a silicon atom represented by Si^{a} in a structure represented by formula (1) and peak PD2 corresponding to a silicon atom represented by Si^{b} in a structure represented by formula (2) are observed, and when an area of the peak PD1 is defined as SD1 and an area of the peak PD2 is defined as SD2, the SD1 and the SD2 satisfy:

1.2≤(SD1+SD2)/SD1≤10.0

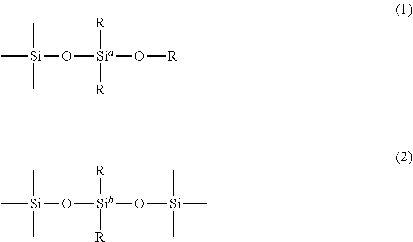

(In the formula, R independently represents a hydrogen atom, a methyl group, or an ethyl group.)

Further features of the present disclosure will become apparent from the following description of exemplary embodiments.

### DESCRIPTION OF THE EMBODIMENTS

In the present disclosure, references to “xx or more and yy or less” and “xx to yy” denote numerical ranges including the lower and upper limits, which are the endpoints, unless otherwise noted.

### Features of the Present Disclosure

The present inventors have studied intensively for the purpose of providing toners with high hot offset resistance and high environmental stability required in the POD field without causing scratch scraping even when strong external stress is applied when using a medium such as coated paper where toner is difficult to fix. As a result, use of a toner comprising a toner particle comprising a hinder resin, and a silica fine particle, wherein the toner particle comprises at least one polyvalent metal element selected from the group consisting of aluminum, iron, zinc, magnesium and calcium, a total content of the polyvalent metal elements in the toner particle, as measured by inductively coupled plasma atomic emission spectroscopy (ICP-AES), is 0.10 to 2.50 μmol/g, a number-average particle diameter of a primary particle of the silica fine particle is 40 nm to 500 nm, and in DD/MAS measurement of solid ²⁹Si-NMR of the silica fine particle, peak PD1 corresponding to a silicon atom represented by Si^{a} in a structure represented by formula (1) and peak PD2 corresponding to a silicon atom represented by Si^{b} in a structure represented by formula (2) are observed, and when an area of the peak PD1 is defined as SD1 and an area of the peak PD2 is defined as SD2, the SD1 and the SD2 satisfy: 1.2≤(SD1+SD2)/SD1≤10.0 did not cause scratch peeling, resulting in high hot offset resistance and high environmental stability.

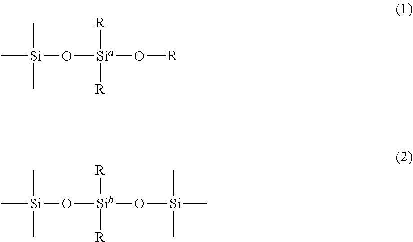

In the formula, R independently represents a hydrogen atom, a methyl group or an ethyl group.

We believe that the reason why the effect of the present disclosure was obtained is as follows.

Scratch peeling, which occurs in media such as coated paper where toner is difficult to fix, is thought to be caused because the surface of coated paper and the toner layer peel off due to strong external stress. Therefore, to prevent toner from scratch peeling, it is necessary to fix the toner sufficiently to the paper.

One way to ensure that the toner is well fixed on the paper is to reduce the melt viscosity of the toner. To achieve this, a means to reduce the molecular weight of the binder resin can be considered, However, when the molecular weight of the binder resin is lowered, the interaction between the molecular chains derived from the entanglement of the molecular chains of the binder resin is lowered, resulting in a lower elasticity of the toner and a lower resistance to hot offset. Another method is to increase the contact area between the binder resin and the paper in the toner. To achieve this, it is possible to reduce the amount of external additives such as silica externally added to the surface of the toner. Generally, the external additives used in the toner have the surface hydrophobized to stabilize the charging of the toner. The hydrophobized external additives are less likely to have interactions with the paper, which is a factor inhibiting the adhesion between the toner and the paper. Therefore, reducing the external additives improves the adhesion of the toner to the paper and does not cause scratch peeling, but reducing the external additives reduces the charging stability of the toner.

As a result of careful consideration, the inventors of the present disclosure have found that by using a toner characterized by the followings, high hot offset resistance and high environmental stability can be obtained without generating scratch peeling.
(i) a toner particle has at least one polyvalent metallic element selected from the group consisting of aluminum, iron, zinc, magnesium, and calcium, and that a total content of the polyvalent metallic element in the toner particle, as measured by inductively coupled plasma atomic emission spectroscopy (ICP-AES), is 0.10 to 2.50 μmol/g, and
(ii) the number-average particle diameter of the primary particle of the silica fine particle to be externally added is 40 to 500 nm, and that in DD/MAS measurement of the solid state ²⁹Si-NMR of the silica fine particle, peak PD1 corresponding to the silicon atom represented by Si^{a} in the structure represented by formula (1) and peak PD2 corresponding to the silicon atom represented by Si^{b} in the structure represented by formula (2) are observed, and that the area of the peak PD1 is SD1 and the area of the peak PD2 is SD2, the SD1 and SD2 are: 1.2>(SD1+SD2)/SD1≤10.0.

The silica fine particle used in the present disclosure has a structure represented by the above formula (1). The structure of the above formula (1) has a polarity because it has OR group at the end, therefore the silica particle interacts with a molecule of a paper thus improving adhesion between the silica particle and the paper. Furthermore, the inclusion of a polyvalent metal in the toner particle allows the polyvalent metal and the above OR group to interact with each other, thus improving adhesion between the silica fine particle and the toner particle. As a result, the toner that does not cause scratch peeling can be obtained. Furthermore, when the amount of polyvalent metals, the number-average particle diameter of silica fine particle, and the above (SD1+SD2)/SD1 in solid-state ²⁹Si-NMR of DD/MAS measurements are in the range of claims, high hot offset resistance and boundary environmental stability can be developed without causing scratch peeling.

For the above reasons, the toner with high hot offset resistance and boundary environmental stability without causing scratch peeling has been obtained.

### Silica Fine Particle

Silica fine particle used in the toner of the present disclosure will be described.

For the silica fine particle used in the toner of the present disclosure, when peak PD1 corresponding to the silicon atom represented by Si^{a} in the structure represented by the above formula (1) and peak PD2 corresponding to the silicon atom represented by Si^{b} in the structure represented by the above formula (2) are observed in DD/MAS measurement of solid state ²⁹Si-NMR and when the area of the peak PD1 is defined as SD1 and the area of the peak PD2 is defined as SD2, the SD1 and SD2 satisfy 1.2≤(SD1+SD2)/SD1≤10.0.

(SD1+SD2)/SD1 represents the length of the siloxane bond treated on the surface of the silica fine particle. The longer the siloxane bond, the greater the likelihood that the silica particle can interact more distantly with the paper molecule or polyvalent metal, but the longer the siloxane bond, the lower the polar of OR group at the end and the weaker the strength of the interaction. Therefore, when (SD1+SD2)/SD1 is in the above range, an effect can be obtained. Preferably the value of (SD1+SD2)/SD1 is 1.2 to 6.2, an effect can be produced more efficiently in the range.

Next, the above NMR measurement method will be described. As a pretreatment for NMR measurement, silica fine particle is separated from toner particle by the following method.

### Method for Separating Silica Fine Particle From Toner Particle

In a 50 mL vial, 20 g of a 10 mass % aqueous solution of “Contaminone N” pH7 precision measuring instrument cleaning neutral detergent consisting of nonionic surfactants, anionic surfactants, and organic builders) is weighed and mixed with 1 g of toner.

The above is set on “KM Shaker” (model: V.SX) manufactured by Iwaki Industries, Ltd., and shaked for 30 seconds at the speed setting of 50. As a result, the externally added silica fine particle move from the surface of the toner particle to the side of aqueous solution. Then, if the toner is a magnetic toner containing a magnetic substance, while the toner particle is restrained using a neodymium magnet, the silica fine particle transferred to the supernatant are separated, and the precipitated toner is dried by vacuum drying (40° C./24 hours) to recover.

If the toner is a non-magnetic toner, a centrifuge (H-9R; manufactured by Kokusan Co., Ltd.) (5 minutes at 1000 rpm) is used to separates the toner and the silica fine particle transferred to the supernatant. The silica fine particle on the surface of the toner particle were removed by the above operation. The recovered toner particles were observed by a scanning electron microscope (SEM) to confirm that the silica fine particles externally added on a surface of the recovered toner particles were completely removed. If silica fine particles remained on the surface of the toner particles, they were dispersed again in water and then shaking operation was performed,

The above procedure was repeated until an NMR measurable amount of silica particle was obtained. ²⁹Si-NMR Measurement Method

Specific measurement conditions for solid state ²⁹Si-NMR are as follows.
Equipment: JNM-ECA400 (JEOL RESONANCE)
Temperature: Room temperature
Measurement method: DD/MAS method ²⁹Si 45°
Sample tube: Zirconia 8.0 mmφ
Sample: Test tube filled with silica particle in powder form
Sample rotation speed: 6 kHz
Relaxation delay: 90 seconds
Scan: 5640

Peak areas SD1, SD2, and SQ for D1 unit Si1, D2 unit Si2, and Q unit Si3 are obtained by peak separation of the peak originating from the siloxane chain appearing at around −20 ppm and the peak originating from the main body of the silica fine particle appearing at around −110 ppm in the NMR spectrum obtained by the measurement described above. The peak separation is performed according to the following procedure.

### Peak Separation Method

Peak separation is performed by extracting and analyzing the NMR spectral data obtained by the above method in CSV format. Peak separation can be performed by using commercially available software or by using a uniquely developed program, as long as following the procedure described below.

The peak position is fixed at −18.2 ppm as the position of the D1 unit Si1 peak and at −21.0 ppm as the position of the D2 unit Si2 peak, and the peak separation process is carried out using the Voigt function.

The above configuration of the present disclosure can be obtained by treating the surface of the silica fine particle precursor with, for example, a treatment agent containing siloxane bonds. Although a known material can be used without limitation for a treatment agent containing siloxane bonds, it is important to treat the surface of the silica fine particle precursor with a treatment agent containing siloxane bonds under certain specific conditions to obtain the configuration of the present disclosure.

Treatment agents containing siloxane bonds include, for example, silicone oil such as dimethyl silicone oil, methyl hydrogen silicone oil, methyl phenyl silicone oil, alkyl modified silicone oil, chloroalkyl modified silicone oil, chlorophenyl modified silicone oil, fatty acid modified silicone oil, polyether modified silicone oil, alkoxy modified silicone oil, carbinol modified silicone oil, amino modified silicone oil, fluorine modified silicone oil, and terminal reactive silicone oil. Preferably used treatment agents are cyclic siloxanes such as hexamethyldisiloxane, octamethyltrisiloxane, hexamethylcyclotrisiloxane, octamethylcyclotetrasiloxane, and decamethylcyclopentasiloxane. The above cyclic siloxanes may have substituents on part of the methyl group attached to the silicon atom. Hexamethylcyclotrisiloxane, octamethylcyclotetrasiloxane and decamethylcyclopentasiloxane are more preferred, especially octamethylcyclotetrasiloxane is preferred from the viewpoint of uniformly coating the surface of the silica fine particle precursor with the molecular structure defined in the present disclosure.

The amount of the surface treatment agent is preferably 5 to 230 parts by mass, and preferably 70 to 200 parts by mass, with respect to 100 parts by mass of the body of the silica fine particle. In particular, when the surface treatment is carried out by contacting the cyclic siloxane by vapor, by adding 100 parts by mass or more to the silica tine particle, the silica fine particle can be uniformly surface treated, and a value of (SD1+SD2)/SQ×100 which is the amount of the surface treatment agent, can be easily controlled.

The above effect can be effectively obtained when the value of (SD1+SD2)/SQ×100 is 1.0 or more.

The above effect can be effectively obtained when the value of (SD1+SD2)/SQ×100 is 2.0 or more, and particularly when the value of (SD1+SD2)/SQ×100 is 3.0 or more.

In the present disclosure, surface treatment of the silica fine particle precursor can be performed by bringing the treating agent containing the siloxane bond into contact with the silica fine particle. From the viewpoint of uniformly forming the configuration of the present disclosure on the surface of the silica fine particle precursor, it is preferable to bring the treating agent into contact with the silica fine particle precursor in a dry manner. As will be described later, a method of bringing a vapor of the treating agent into contact with the silica fine particle precursor or a method of bringing the treating agent into contact with the silica fine particle precursor by spray of undiluted treating agent or spray of diluted solution of the treating agent which are diluted with various solvents can be exemplified. In order to perform the surface treatment efficiently, it is preferable that the treating agent is brought into contact with the silica fine particle precursor while being heated under an inert gas atmosphere such as a nitrogen atmosphere. The heating temperature varies depending on the reactivity and the like of the treating agent used, but is preferably 150 to 380° C., more preferably 300 to 350° C. The treatment time varies depending on the heating temperature and the reactivity of the treating agent used, but is preferably 5 to 300 minutes, more preferably 120 to 180 minutes. It is preferable for the treatment temperature and the treatment time of the surface treatment to be in the above range from the viewpoint that the treating agent can sufficiently react with the silica fine particle substance and from the viewpoint of production efficiency.

The siloxane chains characteristic of the present disclosure can be formed on the surface of silica fine particle by the method described above.

A known material can be used as the silica precursor which is a silica fine particle before surface treatment. Examples include silicon compounds, especially silicon halides, in general silicon chlorides, fumed silica produced by burning purified silicon tetrachloride, wet silica produced from water glass, sol-gel silica particle obtained by wet process, gel silica particle, aqueous colloidal silica particle, alcoholic silica particle, fused silica particle obtained by vapor phase process, deflagration silica particle, etc.

The number-average particle diameter of the primary particle of silica fine particle should be 40 to 500 nm. When the number-average particle diameter is in the above range, an effect can be produced because it can interact with the molecules of paper or the polyvalent metals in the toner particle. 80 to 300 nm is preferable and 100 to 150 nm is more preferable. When the size is in the above range, it becomes possible to develop hot offset resistance and high environmental stability without causing scratch peeling.

### Number-Average Particle Diameter of Silica Fine Particle

Toner particle can be observed by a scanning electron microscope (SEM), and the number of silica fine particles present on the surface of the toner particles and the particle size (maximum diameter) can be measured and determined. If multiple kinds of external additives are added to the toner particle, the Energy Dispersive X-ray Spectroscopy (EDS) accompanying the SEM can be used to confirm that the target of measurement is silica fine particle. The number-average particle diameter is defined as the value measured and averaged for 100 toner particles.

The silica fine particle is preferably contained at 0.01 to 15.0 parts by mass with respect to 100 parts by mass of toner particle, and more preferably 1.0 to 10.0 parts by mass with respect to 100 parts by mass of the binder resin. When the content of the silica fine particle is in the above range, the above effects can be effectively obtained. The silica fine particle can be used alone or in combination of two or more for the toner of the present disclosure.

### Polyvalent Metal/Monovalent Metal

The toner of the present disclosure needs to contain a polyvalent metal in the toner particle. The polyvalent metal used in the present disclosure can be selected from the group consisting of aluminum, magnesium, calcium, and iron. The content of the polyvalent metallic elements in the toner particle is 0.10 to 2.50 μmol/g and is preferably 0.10 to 1.25 μmol/g. When the content is in the above range, the polyvalent metal can effectively interact with the siloxane bond on the surface of the silica fine particle, so that high environmental stability can be developed without causing scratch peeling.

The more detailed content of the above polyvalent metallic elements is 0.50 μmol/g or less for aluminum, and it is more preferably 0.10 to 0.32 μmol/g. The preferable content is 0.80 μmol/g or less for magnesium, 0.90 μmol/g or less for calcium, 1.25 μmol/g or less for iron, and the total content of these 4 polyvalent metallic elements is preferably 0.10 to 1.25 μmol/g. The inventors assume that the preferred ranges differ among the elements due to differences in electronegativity.

There is no particular limitation on the means for including the polyvalent metal element into the toner particle. For example, when the toner particle is produced by a pulverization method, the polyvalent metal element may be included in a resin which is a raw material in advance, or the polyvalent metal element may be added to the toner particle when the raw materials are melt-kneaded. When the toner particle is produced by a wet production method such as a suspension polymerization or an emulsion aggregation, the polyvalent metal element can be included in raw materials or the polyvalent metal element can be added via an aqueous medium in the production process. In particular, for the emulsion aggregation method, it is preferable for the metallic elements to be included in the toner particle through an ionized state in an aqueous medium from the viewpoint of homogeneity.

In addition, the toner particle can contain a monovalent metal. The monovalent metal is preferably at least one selected from the group consisting of Na, Li, and K. By including such a monovalent metal, the toner particle can interact with the siloxane bonds on the surface of the silica fine particle and the above effect can be enhanced.

The content of the monovalent metal is preferably 45 to 90 mass % with respect to the sum of the content of polyvalent and monovalent metals. When the content of the monovalent metal is within the above range, it is preferable in terms of scratch peeling resistance, hot offset resistance and environmental stability.

The content of the monovalent metal is more preferably 50 to 90 mass % with respect to the sum of the content of the polyvalent metal and the content of the monovalent metal. More preferably, the above content is in the range of 55 to 80 mass %.

### Determination of Content of Polyvalent Metallic Elements In Toner Particle (μmol/g)

The content of polyvalent metallic elements in toner particle is quantified by an inductively coupled plasma atomic emission spectroscopy (ICP-AES, manufactured by Seiko Instruments, Inc.).

As a pre-treatment, 100.0 mg of the toner particle is acid decomposed with 8.00 ml of 60% nitric acid (Kanto Chemical, for atomic absorption spectroscopy).

During acid decomposition, the samples are processed in a sealed container at an internal temperature of 220° C. for 1 hour by a microwave high-power sample pretreatment device, ETHOS1600 (manufactured by Milestone General Co., Ltd.) to prepare solution samples containing polyvalent metallic elements.

Ultrapure water is then added to bring the total up to 50.00 g and obtain a measurement sample. A calibration curve is prepared for each polyvalent metallic element, and the amount of metal contained in each sample is determined. Ultrapure water is added to 8.00 ml of nitric acid to make a total of 50.00 g, which is measured as a blank, and the amount of metal in the blank is subtracted.

### Binder Resin for Toner Particle

Known binder resins can be used for the toner particle applicable to the present disclosure.

For example, the binder resins include the following: styrenic resin, styrenic copolymer resin, polyester resin, polyol resin, polyvinyl chloride resin, phenolic resin, natural resin-modified phenolic resin, natural resin-modified maleic acid resin, acrylic resin, methacrylic resin, polyvinyl acetate, silicone resin, polyurethane resin, polyamide resin, furan resin, epoxy resin, xylene resin, polyvinyl butyral, terpene resin, coutnarone indene resin, and petroleum-based resin. Preferably used resins include styrenic copolymer resin, polyester resin, and hybrid resin in which polyester resin and styrenic copolymer resin are mixed or partially reacted, In particular, polyester resin is preferable in terms of bending resistance and hot offset resistance because it can interact with ester bonds of polyester resin and siloxane bonds on the surface of silica fine particle. The components constituting polyester resin are described in detail. One or more of the following components may be used depending on the type and application.

The following dicarboxylic acids or their derivatives are cited as the bivalent acid components constituting the polyester resin. Benzene dicarboxylic acids such as phthalic acid, terephthalic acid, isophthalic acid, phthalic anhydride, or their anhydrides or their lower alkyl esters; alkyl dicarboxylic acids such as succinic acid, adipic acid, sebacic acid, azelaic acid, or their anhydrides or their lower alkyl esters; alkenyl succinic acids or alkyl succinic acids with an average carbon number of 1 to 50, or their anhydrides or their lower alkyl esters; unsaturated dicarboxylic acids such as fumaric acid, maleic acid, citraconic acid and itaconic acid, or their anhydrides or their lower alkyl esters. The alkyl groups in the lower alkyl esters include methyl, ethyl, propyl, and isopropyl groups.

The bivalent alcohol components constituting polyester resin include the following: ehylene glycol, polyethylene glycol, 1,2-propanediol, 1,3-propanediol, 1,3-butanediol, 1,4-butanediol, 2,3-butanediol, diethylene glycol, triethylene glycol, 1,5-pentanediol, 1,6-hexanediol, neopentyl glycol, 2-methyl-1,3-propanediol, 2-ethyl-1,3-hexanediol, 1,4-cyclohexanedimethanol (CHDM), hydrogenated bisphenol A, bisphenols represented by formula (I-1) and their derivatives: and dials represented by formula (I-2).

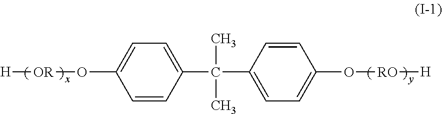

In formula (I-1), R is an ethylene group or a propylene group, and x and y are integers not less than 0, respectively, and the average value of x+y is 0 to 10.

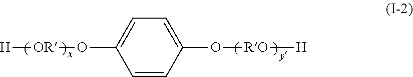

In formula (I-2), R′ is an ethylene group or a propylene group, x′ and y′ are integers of 0 or more, and the average value of x′+y′ is 0 to 10.

The constituent of the polyester resin may contain a trivalent or more carboxylic acid compound or a trivalent or more alcohol compound as a constituent other than the aforementioned divalent carboxylic acid compound and divalent alcohol compound.

Trimellitic acid, trimellitic anhydride and pyromellitic acid are examples of trivalent or more carboxylic acid compounds that are not particularly restricted. Trimethylolpropane, pentaerythritol and glycerin are examples of trivalent or more alcoholic compounds.

The constituent of the polyester resin may contain a monovalent carboxylic acid compound and a monovalent alcohol compound as constituent components in addition to the compounds described above. Specifically, the monovalent carboxylic acid compounds include palmitic acid, stearic acid, arachidic acid, behenic acid and the like. Also, serotic acid, heptacosanoic acid, montanoic acid, melicinic acid, laccelic acid, tetracontanoic acid, pentacontanoic acid and the like are mentioned.

Monovalent alcohol compounds include behenyl alcohol, seryl alcohol, melisyl alcohol and tetracontanol.

In the present disclosure, there are no particular restrictions on the method for producing polyester, and known methods can be used. For example, the aforementioned divalent carboxylic acid compound and divalent alcohol compound are polymerized through esterification or transesterification and condensation reactions to produce a polyester resin. The polymerization temperature is not particularly limited, but is preferably in the range of 180 to 290° C. When the polyester resin is polymerized, for example, a titanium-based catalyst, a tin-based catalyst, a polymerization catalyst such as zinc acetate, antimony trioxide or germanium dioxide can be used.

The weight-average molecular weight (Mw) of the binder resin is preferably 4,000 to 100,000, and more preferably 25,000 to 60,000 based on the molecular weight distribution by GPC, so that scratch peeling resistance, hot offset resistance and environmental stability are also good. In addition, the ratio of weight-average molecular weight to number-average molecular weight (Mw/Mn) of 5 to 10 is also preferable for the same purpose.

### Molecular Weight Measurement of Binder Resin and Toner

The molecular weight distribution of THF-soluble fraction of binder resin and toner is measured by gel permeation chromatography (GPC) as follows.

First, the toner is dissolved in tetrahydrofuran (THF) over 24 hours at room temperature to obtain a solution. The obtained solution is then filtered through a solvent-resistant membrane filter “Maeshori Disc” (manufactured by Tosoh Co., Ltd.) with a pore diameter of 0.2 μm to obtain a sample solution. The sample solution is adjusted so that the concentration of THF-soluble components is about 0.8 mass %. The sample solution is used to measure under the following conditions;
Equipment: HLC8120 GPC (detector: RI) (manufactured by Tosoh Corporation)
Column: Shodex KF-801, 802, 803, 804, 805, 806, 807 in 7 columns (manufactured by Shown Denko Corporation),
Eluent: Tetrahydrofuran (THF),
Flow rate: 1.0 mL/min,
Oven temperature: 40.0° C., and
Sample injection volume: 0.10 mL.

For calculation of a molecular weight of a sample, for example, a molecular weight calibration curve prepared using a standard polystyrene resin manufactured by Tosoh Co., Ltd., as described below is used.

Standard polystyrene resin: Trade name “TSK. Standard Polystyrene F-850, F-450, F-288, F-128, F-80, F-40, F-20, F-10, F-4, F-2, F-1, A-5000, A-2500, A-1000, A-500”.

The glass transition temperature Tg of the binder resin in the present disclosure is preferably 50 to 65° C., and more preferably 51 to 62° C. When the glass transition temperature of the binder resin is in the above range, the polyvalent metal and the silica fine particle can interact with each other, which improves scratch peeling resistance, hot offset resistance and environmental stability.

### Measurement of Glass Transition Temperature (Tg) of Binder Resin

The glass transition temperature of binder resin is measured according to ASTM D3418-82 using a differential scanning calorimeter “Q 2000” (manufactured by TA Instruments).

The temperature at the detection unit of the instrument is corrected on the basis of the melting points of indium and zinc, and the amount of heat is corrected on the basis of the heat of fusion of indium.

Specifically, about 3 mg of resin or toner is weighed exactly, and placed in an aluminum pan, and measured using an empty aluminum pan as a reference under the following conditions;
Heating rate: 10° C./min,
Measuring start temperature: 20° C., and
Measuring end temperature: 180° C.

Measurement is conducted at a temperature rise rate of 10° C./min within a measurement range of 20° C. to 180° C., The temperature is increased to 180° C. and hold for 10 minutes, then decreased to 20° C., and then increased again. The change of specific heat is observed in the temperature, range of 20° C. to 100° C. during the above second raising temperature process. The temperature at the intersection of a line equidistant in the longitudinal direction from “the baseline before the specific heat change” and “the baseline after the specific heat change” and the differential heat curve is defined as the glass transition temperature (Tg, also called the mid-point glass transition temperature) of the resin.

The acid value of the binder resin in the present disclosure is preferably 5.0 mgKOH/g or more. Furthermore, when the acid value is 10.0 mgKOH/g or more, scratch peeling resistance, hot offset resistance and environmental stability are excellent because the polyvalent metal and the silica fine particle can interact.

### Method for Measuring Acid Value of Binder Resin

The acid value is a numerical value of milligrams of potassium hydroxide required to neutralize the acid contained in 1 g of a sample The acid value of the binder resin is measured according to JIS K 0070-1992, specifically, the following procedure is followed.

### (1) Preparation of Reagent

Phenolphthalein 1.0 g is dissolved in 90 ml of ethyl alcohol (95 vol %), ion exchanged water is added to bring the total up to 100 mL to obtain a solution of phenolphthalein.

Special grade potassium hydroxide 7 g is dissolved in 5 mL of water, and add ethyl alcohol (95 vol %) to bring the total up to 1 L for obtaining a solution. The solution is placed in an alkaline proof container for 3 days to avoid contact with carbon dioxide, etc., and filtered to obtain a potassium hydroxide solution. The resulting potassium hydroxide solution is stored in an alkaline proof container. A total of 25 mL of 0.1 mol/L hydrochloric acid is placed in a conical flask, a few drops of the phenolphthalein solution are added, titration is performed with the potassium hydroxide solution, and a factor of the potassium hydroxide solution is obtained from the amount of the potassium hydroxide solution required for neutralization. 0.1 mol/L hydrochloric acid solution is prepared according to JIS K 8001-1998.

### (2) Operation

### (A) Main Test

A total of 2.0 g of the crushed sample is accurately weighed into a 200 mL into a conical flask, 100 mL of a mixed solution of toluene/ethanol (2:1) is added, and dissolution is performed over 5 hours. Then, a few drops of the phenolphthalein solution are added as an indicator, and titration is performed using the potassium hydroxide solution. A light red color of the indicator for about 30 seconds was used as the endpoint of the titration.

### (B) Blank Test

The same titration as described above is performed except that no sample is used. (i.e., only a toluene/ethanol (2:1) mixture is used).

(3) The acid value was calculated by substituting the obtained result into the following formula:

A=[(C−B)×f×5.61]/S

where A: the acid value (mgKOH/g), B: the amount of potassium hydroxide solution added in the blank test (mL), C: the amount of potassium hydroxide solution added in the main test (mL), f: the factor of potassium hydroxide solution, S: the sample (g).

### Other Constituents of Toner Particle

The toner of the present disclosure can be used as either magnetic one-component toner, non-magnetic one-component toner or non-magnetic two-components toner.

When used as magnetic one-component toner, magnetic iron oxide particle is preferably used as the colorant. As the magnetic iron oxide particle contained in the magnetic one-component toner, magnetic iron oxides such as magnetite, maghemite, ferrite, and magnetic iron oxides including other metal oxides; metals such as Fe, Co, Ni, or alloys of these metals with metals such as Al, Co, Cu, Pb, Mg, Ni, Sn, Zn, Sb, Be, Bi, Cd, Ca, Mn, Se, Ti, W, V, and mixtures thereof.

The content of the magnetic iron oxide particle is preferably 30 to 150 parts by mass with respect to 100 parts by mass of the binder resin.

The following colorants are used as nonmagnetic toners for the nonmagnetic one-component development system and the two-components development system.

As the black pigment, carbon black such as furnace black, channel black, acetylene black, thermal black and lamp black is used, and magnetic powders such as magnetite and ferrite are also used.

A pigment or a dye can be used as a colorant suitable for yellow color Examples of pigments include C.I.Pigment Yellow 1, 2, 3, 4, 5, 6, 7, 10, 11,12, 13, 14, 15, 17, 23, 62, 65, 73, 74, 81, 83, 93, 94, 95, 97, 98, 109, 110, 111, 117, 120, 127, 128, 129, 137, 138, 139, 147, 151, 154, 155, 167, 168, 173, 174, 176, 180, 181, 183, 191, and C.I.Bat Yellow 1, 3, 20. Examples of dyes include C.I.Solvent Yellow 19, 44, 77, 79, 81, 82, 93, 98, 103, 104, 112, 162, etc. These are used alone or in combination with 2 or more.

A pigment or a dye can be used as a colorant suitable for cyan color. Examples of pigments include C.I.Pigment Blue 1, 7, 15, 15:1, 15:2, 15:3, 15:4, 16, 17, 60, 62, 66, etc., C.I,Bat Blue 6, and C.I.Acid Blue 45. Examples of dyes include C.I.Solvent Blue 25, 36, 60, 70, 93, 95, etc. These are used alone or in combination with 2 or more.

A pigment or a dye can e used as a colorant suitable for magenta color. As pigments, C.I.Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:2, 48:3, 48:4, 49, 50, 51, 52, 53, 54, 55, 57, 57:1, 58, 60, 63, 64, 68, 81, 81:1, 83, 87, 88, 89, 90, 112, 114, 122, 123, 144, 146, 150, 163, 166, 169, 177, 184, 185, 202, 206, 207, 209, 220, 221, 238, 254, etc., C.I.Pigment Violet 19; C.I.Ba Red 1, 2, 10, 13, 15, 23, 29, 35. Examples of magenta dyes include C.I.Solvent Red 1, 3, 8, 23, 24, 25, 27, 30, 49, 52, 58, 63, 81, 82, 83, 84, 100, 109, 111, 121, 122, etc., C.I.Disperse Red 9, C.I.Solvent Violet 8, 13, 14, 21, 27, etc., oil lytic dyes such as C.I. Disperse Violet 1, etc., C.I. Basic Red 1, 2, 9, 12, 13, 14, 15, 17, 18, 22, 23, 24, 27, 29, 32, 34, 35, 36, 37, 38, 39, 40, etc., basic dyes such as C.I. Basic Violet 1, 3, 7, 10, 14, 15, 21, 25, 26, 27, 28, etc. These are used alone or in combination of 2 or more, Pigment red 122 is preferred.

The content of the colorant is preferably 1 to 20 parts by mass with respect to 100 parts by mass of the binder resin.

A release agent (wax) may be used to impart release property to the toner. Examples of wax include: aliphatic hydrocarbon waxes such as low molecular weight polyethylene, low molecular weight polypropylene, olefin copolymers, microcrystalline waxes, paraffin waxes, and Fischer Tropsch waxes; oxidized waxes of aliphatic hydrocarbon waxes such as oxidized polyethylene waxes; waxes consisting mainly of fatty acid esters such as carnauba wax, behenyl behenate, and montanoate ester wax; and partially or wholly deoxidized fatty acid esters such as deoxidized carnauba wax. In addition, saturated linear fatty acids such as palmitic acid, stearic acid and montanic acid; unsaturated fatty acids such as brushic acid, eleostearic acid, and valinaric acid; saturated alcohols such as stearyl alcohol, aralkyl alcohol, behenyl alcohol, carnaubyl alcohol, seryl alcohol, and melisyl alcohol; polyvalent alcohols such as sorbitol; fatly acid amides such as linoleic, oleic, and lauric acid amides; saturated fatty acid bisamides such as methylenebisstearic, ethylenebiscapric, ethylenebislauric, and hexamethylenebisstearic acid amides; unsaturated fatty amides acid amides; unsaturated acid such as ethylenebisoleic, hexamethylenebisoleic, N,N′-dioleyladipic, and N,N′-dioleylsebacic acid amides; aromatic bisamides such as m-xylene bisstearic, N,N′-distearyl isophthalic acid amides; aliphatic metal salts such as calcium stearate, calcium laurate, zinc stearate and magnesium stearate (commonly referred to as metal soaps); waxes grafted with vinyl copolymer monomers such as styrene and acrylic acid onto aliphatic hydrocarbon wax; partial esterification of fatty acids and polyalcohols such as monoglycerides of behenate; methyl ester compounds with hydroxy groups obtained by hydrogenation of vegetable oils and fats are examples.

A particularly preferred wax is an aliphatic hydrocarbon wax. For example, a low-molecular-weight hydrocarbon polymerized by radical polymerization of alkylene under high pressure or by Ziegler and metallocene catalysts under low pressure; Fischer-Tropsch wax synthesized from coal or natural gas; paraffin wax; olefin polymer obtained by pyrolysis of a high-molecular-weight olefin polymer; a synthetic hydrocarbon wax obtained from the distillation residue of hydrocarbons obtained by the Arge method from a synthetic gas containing carbon monoxide and hydrogen, or a synthetic hydrocarbon wax obtained by hydrogenation of these, is preferred. In addition, fractionation of the hydrocarbon wax by the use of the press sweating method, solvent method, vacuum distillation or fractionation crystallization method is more preferably used. Among the above paraffin waxes, n-paraffin wax and Fischer-Tropsch wax, in which the linear component is the main component, are particularly preferred from the viewpoint of molecular weight distribution.

It is possible to use one of these waxes alone, or two or more thereof in combination. It is preferable to add 1 to 20 parts by mass of the wax with respect to 100 parts by mass of the binder resin.

The toner of the present disclosure can use a known charge control agent as the charge control agent. Known charge control agents include azo-based iron compounds, azo-based chromium compounds, azo-based manganese compounds, azo-based cobalt compounds, azo-based zirconium compounds, chromium compounds of carboxylic acid derivatives, zinc compounds of carboxylic acid derivatives, aluminum compounds of carboxylic acid derivatives, and zirconium compounds of carboxylic acid derivatives. The aforementioned carboxylic acid derivatives are preferably aromatic hydroxycarboxylic acids, A charge controlling resin can also be used. One or 2 or more charge controlling agents may be used in combination as needed. It is preferable to add 0.1 to 10 parts by mass of the charge controlling agent with respect to 100 parts by mass of the binder resin.

### Other External Additive

Other external additive may be added to the toner according to the present disclosure along with the above silica fine particle according to the present disclosure, if necessary. Examples of such external additives include a charging aid, a conductivity imparting agent, a fluidity imparting agent, a caking inhibitor, a release agent for heat roller fixing, a lubricant and a resin fine particle and an inorganic fine powder that act as an abrasive. Metal oxides such as silica, titanium oxide, zinc oxide and alumina are exemplified as charging aids. Polyfluoroethylene powder, zinc stearate powder and polyvinylidene fluoride powder are exemplified as lubricants. Cerium oxide powder, silicon carbide powder and strontium titanate powder are exemplified as abrasives.

The mixing of toner particle with an external additive can be performed using a known mixer such as a Henschel mixer, but the apparatus is not particularly limited.

The amount of other external additives to be added is preferably 0.01 to 10.0 parts by mass with respect to 100 parts by mass of toner particle.

### Method for Producing Toner Particle

The method for producing toner particle in the present disclosure is not particularly limited and can be produced by a known method. Examples include emulsion aggregation, pulverization, suspension polymerization, dissolution suspension, and the like.

### Emulsion Aggregation Method

An emulsion aggregation method is a method in which toner particle are produced by first preparing an aqueous dispersion liquid of fine particle which comprise the constituent materials of the toner particle and which are substantially smaller than the desired particle size, and then aggregating the fine particle in an aqueous medium until the particle size of the toner particle is reached, and then carrying out heating or the like so as to fuse the resin. That is, in an emulsion aggregation method, a toner is produced by carrying out a dispersion step for producing fine particle-dispersed solutions comprising constituent materials of the toner; an aggregation step for aggregating fine particle comprising the constituent materials of the toner so as to control the particle size until the particle size of the toner is reached; a fusion step for subjecting the resin contained in the particle obtained by the aggregation step to melt adhesion; a cooling step thereafter; a metal removal step for filtering the obtained toner and removing excess polyvalent metal ions; a filtering/washing step for filtering the obtained toner and washing with ion exchanged water or the like; and a step for removing water from the washed toner and drying.

### Step for Preparing Resin Fine Particle Dispersion Solution (Dispersion Steps)

A resin fine particle dispersion solution can be prepared using a well-known method, but is not limited to such methods. Examples of well-known methods include an emulsion polymerization method, a self-emulsification method, a phase inversion emulsification method in which an aqueous medium is added to a resin solution dissolved in an organic solvent so as to emulsify the resin, or a forcible emulsification method in which a resin is subjected to a high temperature treatment in an aqueous medium without using an organic solvent so as to forcibly emulsify the resin.

Specifically, the binder resin is dissolved in an organic solvent that can dissolve these components, and a surfactant and a basic compound are added. In such cases, if the binder resin is a crystalline resin having a melting point, the resin should be melted by being heated to the melting point of the resin or higher. Next, resin fine particle is precipitated by slowly adding an aqueous medium while agitating by means of a homogenizer or the like. A resin fine particle-dispersion aqueous solution is then prepared by heating or lowering the pressure so as to remove the solvent. Any solvent able to dissolve the resin mentioned above can be used as the organic solvent used for dissolving the resin, but use of an organic solvent that forms a uniform phase with water, such as toluene, is preferred from the perspective of suppressing the generation of coarse particle.

The type of surfactant used in the emulsification mentioned above is not particularly limited, but examples thereof include anionic surfactants such as sulfate ester salts, sulfonic acid salts, carboxylic acid salts, phosphate esters and soaps; cationic surfactants such as amine salts and quaternary ammonium salts; and non-ionic surfactants such as polyethylene glycol type surfactants, adducts of ethylene oxide to alkylphenols, and polyhydric alcohol type surfactants. It is possible to use one of these surfactants alone, or two or more thereof in combination.

Examples of the basic compound used in the dispersion step include inorganic bases such as sodium hydroxide and potassium hydroxide, and organic bases such as ammonia, triethylamine, trimethylamine, dimethylaminoethanol and diethylaminoethanol. It is possible to use one of these basic compounds alone or two or more thereof in combination.

The 50% particle diameter (D50) of the volume distribution standard of the fine particle of the binder resin in the aqueous dispersion of the fine particle of the resin is preferably 0.05 to 1.0 μm, and more preferably 0.05 to 0.4 μm. By adjusting the 50% particle diameter (D50) of the volume distribution standard to the above range, it becomes easy to obtain toner particle with an appropriate weight-average particle diameter of 3 to 10 μm as the toner particle.

For the measurement of 50% particle diameter (D50) based on the volume distribution standard, a dynamic light scattering particle size distribution meter, Nanotrac UPA-EX150 (manufactured by Nikkiso Co., Ltd.), is used.

### Colorant Fine Particle Dispersion

The colorant fine particle dispersion used as needed can be prepared by the known methods listed below, but is not limited to these methods.

The colorant fine particle dispersion can be prepared by mixing a colorant, an aqueous medium and a dispersant by using mixers such as known agitators, emulsifiers and dispersers. The dispersant used here can be a known surfactant and a polymer dispersant.

Both a surfactant and a polymer dispersant can be removed in the washing step described later, but from the viewpoint of washing efficiency, a surfactant is preferred.

As surfactants, anionic surfactants such as sulfate ester salt type, sulfonate salt type, phosphate ester type, and soap surfactants are preferred; cationic surfactants such as amine salt and quaternary ammonium salt; nonionic surfactants such as polyethylene glycol type, alkylphenol ethylene oxide adduct type, and polyalcohol type are mentioned.

Among these, nonionic surfactants or anionic surfactants are preferred. In addition, nonionic surfactants and anionic surfactants may be used in combination. It is possible to use one of these surfactants alone or two or more thereof in combination. The concentration of the surfactants in an aqueous medium is preferably 0.5 to 5 mass %.

The content of the colorant fine particle in the colorant fine particle dispersion is not particularly limited, but is preferably 1 to 30 mass % with respect to the total mass of the colorant fine particle dispersion.

In addition, the dispersing particle size of the colorant tine particle in the aqueous dispersion of the colorant preferably has a 50% particle diameter (D50) based on the volume distribution standard of 0.5 μm or less in view of the dispersibility of the colorant in the finally obtained toner. For the same reason, it is also preferable that the 90% particle diameter (D90) based on the volume distribution standard is 2 μm or less. The dispersed particle size of the colorant fine particle dispersed in the aqueous medium is measured by a dynamic light scattering particle size distribution meter (Nanotrac UPA-EX150: manufactured by Nikkiso Co., Ltd.).

Examples of known mixing machines such as stirring machines, emulsifying machines and dispersing machines used when dispersing the colorant in the aqueous medium include ultrasonic homogenizers, jet mills, pressurized homogenizers, colloid mills, ball mills, sand mills and paint shakers. It is possible to use one of these mixing machines in isolation, or a combination thereof.

### Release Agent (Aliphatic Hydrocarbon Compound) Fine Particle Dispersion

A release agent fine particle dispersion may be used if necessary. The release agent fine particle dispersion can be prepared using the known method given below, but is not limited to this well-known method.

The release agent fine particle dispersion can be prepared by adding a release agent to an aqueous medium containing a surfactant, heating to a temperature that is not lower than the melting point of the release agent, dispersing in a particulate state using a homogenizer having a strong shearing capacity (for example, a “Clearmix W-Motion” manufactured by M Technique Co., Ltd.) or a pressure discharge type dispersing machine (for example, a “Gaulin homogenizer” manufactured by Gaulin), and then cooling to a temperature that is lower than the melting point of the release agent.

The dispersed particle size of the release agent fine particle dispersion in the aqueous dispersion of the release agent is such that the 50% particle diameter of volume distribution standard (D50) is preferably 0.03 μm to 1.0 μm, and more preferably 0.1 μm to 0.5 μm. In addition, it is preferable for coarse particle having diameters of at least 1 μm not to be present.

If the dispersed particle size in the release agent fine particle dispersion solution falls within the range mentioned above, the release agent can be finely dispersed in the toner, an outmigration effect can be exhibited to the maximum possible extent at the time of fixing, and good separation properties can be achieved. Moreover, the dispersed particle size of the release agent tine particle-dispersion solution dispersed in the aqueous medium can be measured using a dynamic light scattering particle size distribution analyzer (a Nanotrac UPA-EX150 manufactured by Nikkiso Co., Ltd.).

### Mixing Step

In the mixing step, a mixed solution is prepared by mixing the resin fine particle dispersion and, if necessary; at least one of the release agent fine particle dispersion and the colorant fine particle dispersion. It is possible to use a known mixing apparatus, such as a homogenizer or a mixer.

### Step for Forming Aggregate Particle (Aggregation Step)

In the aggregation step, fine particle contained in the mixed solution prepared in the mixing step are aggregated so as to form aggregates having the target particle size. Here, by adding and mixing a flocculant and applying heat and/or a mechanical force as appropriate if necessary, aggregates are formed through aggregation of resin fine particle and, if necessary, release agent fine particle and/or colorant fine particle.

The aggregation agent is an agent preferably containing metal ions of a polyvalent metal, and the polyvalent metal is at least one selected from the group consisting of Mg, Ca, Al, Fe and Zn.

The aggregation agent containing metal ions of the polyvalent metal has a high aggregating force and can achieve its purpose by adding a small amount. These aggregation agents can ionically neutralize ionic surfactants contained in resin fine particle dispersions, release agent fine particle dispersions, and colorant fine particle dispersions. As a result, a binder resin fine particle, a release agent fine particle, and a colorant fine particle are aggregated by the effect of salting and ion crosslinking.

Metal salts of polyvalent metals or polymers of metal salts are cited as coagulants containing metal ions of polyvalent metals. Specifically, bivalent inorganic metal salts such as calcium chloride, calcium nitrate, magnesium chloride, magnesium sulfate, and zinc chloride are cited. Also, trivalent metal salts such as iron (III) chloride, iron (III) sulfate, aluminum sulfate, and aluminum chloride are cited. Also, inorganic metal salt polymers such as polyferric sulfate, polyaluminum chloride, polyaluminum hydroxide, and calcium polysulfide are cited but not limited to. One of these may be used alone, or two or more may be used together. Among these coagulants, aluminum-based coagulants are preferred.

The aggregation agent may be added in either the form of a dry powder or an aqueous solution dissolved in an aqueous medium, but it is preferable to add it in the form of an aqueous solution in order to cause uniform aggregation.

The addition and mixing of the aggregation agent are preferably carried out at a temperature below the glass transition temperature or melting point of the resin contained in the mixture. By mixing under this temperature condition, aggregation proceeds relatively uniformly. The mixing of the aggregation agent into the mixture can be performed using a known mixing device such as a homogenizer and a mixer. The aggregation step is a step of forming an aggregate of toner particle size in an aqueous medium. The volume-average particle diameter of the aggregate produced in the aggregation step is preferably 3 to 10 μm. The volume-average particle diameter can be measured by a particle size distribution analyzer (Coulter Multisizer III, manufactured by Coulter) by the Coulter method.

### (Step for Obtaining Dispersion Containing Toner Particle (Fusion Step))

In the fusion step, an aggregation stopping agent is added to the dispersion containing aggregates obtained in the aggregation step under the same stirring as in the aggregation step. Examples of the aggregation stopping agent include chelating agents that stabilize aggregation particle by partially dissociating ion crosslinks between acidic polar groups of surfactants and metal ions that are aggregation agents to form coordination bonds with the metal ions. Since the amount of interaction between silica tine particle and polyvalent metals can be optimally controlled by the addition of the aggregation stopping agent, scratch peeling resistance, hot offset resistance and environmental stability can be exhibited.

The aggregation stopping agent acts to stabilize a condition of a dispersion of aggregation particle in the dispersion liquid, and then the aggregation particle are fused by heating above the glass transition temperature or melting point of the binder resin.

The chelating agent is not limited as long as it is a well-known water-soluble chelating agent. Specifically, oxycarboxylic acids such as tartaric acid, citric acid, and gluconic acid, and their sodium salts; iminodiic acid (IDA), nitrilotriacetic acid (NTA), and ethylenediaminetetraacetic acid (EDTA), and their sodium salts; are listed.

The chelating agent is coordinated to the metal ion of the aggregation agent present in the dispersion of the aggregated particle, so that the environment in the dispersion can be changed from an electrostatically unstable state in which aggregation can easily occur to an electrostatically stable state in which further aggregation is unlikely to occur. As a result, it is possible to suppress further aggregation of the aggregated particle in the dispersion and to stabilize the aggregated particle.

The chelating agent is preferably an organic metal salt having a carboxylic acid having a valency of 3 or more, since even small amounts of such chelating agent can be effective and toner particle having a sharp particle size distribution can be obtained.

Further, from the viewpoint of achieving both stabilization from the aggregation state and washing efficiency, the addition amount of the chelating agent is preferably 1 to 30 mass parts and more preferably 2.5 to 15 mass parts with respect to 100 mass parts of the binder resin. The volume-based 50% particle diameter (D50) of the toner particle is preferably 3 μm to 10 μm.

### (Cooling Step)

If necessary, in the cooling step, the temperature of the dispersion solution including the toner particle obtained in the fusion step can also be reduced to a temperature lower than at least one of the crystallization temperature and glass transition temperature of the binder resin. By cooling to a temperature lower than at least one of the crystallization temperature and glass transition temperature, it is possible to prevent the generation of coarse particle. The specific cooling rate can be 0.1 to 50° C./min.

### Metal Removal Step

In the toner producing method, it is preferable to include a metal removal step in which a chelating compound having a chelating function with respect to metal ions is added to a dispersion containing the toner particle to remove at least part of the polyvalent metal element and thereby adjust the content of the polyvalent metal element. The concentration distribution of the polyvalent metal element on the toner particle surface can be controlled by means of the metal removal step. Specifically, the concentration of the polyvalent metal element in the toner particle surface layer can be made lower than the concentration of the polyvalent metal element in the toner particle interior.

The chelating compound is not particularly limited as long as it is a known water-soluble chelating agent, and the chelating agent described above may be used. Because the metal removal ability of a water-soluble chelating agent is extremely sensitive to temperature, the metal removal step is preferably performed at a temperature of 40 to 60° C. more preferably at about 50° C.

### Washing Step

If necessary, impurities in the toner particle can be removed by repeating the washing and filtration of the toner particle obtained in the cooling step in the washing step. Specifically, it is preferable to wash the toner particle by using an aqueous solution including a chelating agent such as ethylenediaminetetraacetic acid (EDTA) and a Na salt thereof, and further wash with pure water. By repeating washing with pure water and filtration a plurality of times, metal salts and surfactants in the toner particle can be removed, The number of filtrations is preferably 3 to 20 and more preferably 3 to 10 from the viewpoint of production efficiency.

### Drying Step

In the drying step, if necessary, the toner particle obtained in the above step are dried.

### External Addition Step

The obtained toner particle in the drying step may also be used as is as a toner.

In the external addition step, an inorganic particle is externally added as necessary to the toner particle obtained in the drying step. Specifically, an inorganic fine particle of silica or the like or a resin particle of a vinyl resin, polyester resin, silicone resin or the like is preferably added by applying shear force in a dry state.

For example, a mixture of the toner particle and inorganic fine particle together with other external additives can be mixed with a mixing apparatus such as a double cone mixer, V mixer, drum. mixer, Super mixer, Henschel mixer, Nauta mixer, Mechano Hybrid (Nippon Coke & Engineering Co., Ltd.), Nobilta (Hosokawa Micron Corporation) or the like.

### Pulverizing Method

The toner particle produced by the pulverizing method are produced as follows, for example. A binder, a colorant and other additives as needed, etc. are sufficiently mixed by a mixer such as a Henschel mixer or a ball mill. The mixture is melt-kneaded using a thermal kneader such as a twin-screw kneading extruder, heating roll, kneader or extruder.

At this time, wax, magnetic iron oxide particle and metal-containing compounds may also be added. After cooling and solidifying the melt mixture, Pulverizing and classification are performed to obtain a toner particle. At this time, the average circularity of the toner particle can be controlled by adjusting the exhaust temperature at the time of tine grinding. In addition, the toner particle and the external additives can be mixed by a mixer such as a Henschel mixer as needed to obtain the toner.

Examples of mixers include the following; Henschel mixer (manufactured by Mitsui Mining corporation); Super mixer (manufactured by Kawata Manufacturing corporation); Ribocone (manufactured by Okawara Mfg. corporation); Nauta Mixer, Turbulizer and Cyclomix mixer (manufactured by Hosokawa Micron Corporation); Spiral pin mixer (manufactured by Pacific Machinery & Engineering corporation), or a Loedige mixer (manufactured by Matsubo corporation).

Examples of kneading machines include the following, KRC kneader (manufactured by Kurimoto, Ltd.); Buss Co-Kneader (manufactured by Buss AG); TEM extruder (manufactured by Toshiba Machine Co., Ltd.); TEX twin-screw kneader (manufactured by Japan Steel Works, Ltd.); PCM kneader (manufactured by Ikegai Corp); a triple roll mill, a mixing roll mill and a kneader (manufactured by Inoue Mfg., Inc.); Kneader (manufactured by Mitsui Mining Corporation); MS Pressure kneader or Kneader-Ruder (manufactured by Moriyama Seisakusho corporation), or Banbury Mixer (manufactured by Kobe Steel, Ltd.). Examples of pulverizing machines include the following; Counter Jet Mill, Micron Jet, Inomizer (manufactured by Hosokawa Micron Corporation); IDS Mill or PJM Jet pulverizer (manufactured by Nippon Pneumatic Mfg. Co., Ltd.); Cross Jet Mill (manufactured by Kurimoto, Ltd.); Ulmax (manufactured by Nisso Engineering Co., Ltd.); SK Jet-O-Mill (manufactured by Seishin Enterprise Co., Ltd.); Kryptron (manufactured by Kawasaki Heavy Industries, Ltd.); Turbo Mill (manufactured by Freund-Turbo Corporation); and Super Rotor (manufactured by Nisshin Engineering Inc.).

If necessary, after pulverizing, the surface treatment of the toner particle can also be performed to control the average circularity of the toner particle by using Hybridization System (manufactured by Nara Machinery Co., Ltd.), Nobilta (manufactured by Hosokawa Micron Co., Ltd.), Mechanofusion System (manufactured by Hosokawa Micron Co., Ltd.), Faculty (manufactured by Hosokawa Micron Co., Ltd.), Inomizer (manufactured by Hosokawa Micron Co., Ltd.), Theta Composer (manufactured by Tokuju Machinery Co., Ltd.), Mechanomill (manufactured by Okada Seiko Co., Ltd.), and Meteo Rainbow MR Type (manufactured by Japan Pneumatic Co., Ltd.).

Examples of classifiers include the following; Classiel, Micron Classifier and Spedic Classifier (manufactured by Seishin Enterprise Co., Ltd.); Turbo Classifier (manufactured by Nisshin Engineering Inc.); Micron Separator and Turboplex (manufactured by ATP Ltd.); TSP Separator (manufactured by Hosokawa Micron Corporation); Elbow Jet (manufactured by Nittetsu Mining Co., Ltd.); Dispersion Separator (manufactured by Nippon Pneumatic Mfg. Co., Ltd.); and YM Microcut (manufactured by Yasukawa Shoji Ltd.).

Examples of sieving devices used for sieving coarse particle include the following; Ultrasonic (manufactured by Koei Sangyo Co., Ltd.); Resona Sieve and Gyro Shifter (manufactured by Tokuju Co., Ltd); Vibrasonic System (manufactured by Dalton Co., Ltd.); Soniclean (manufactured by Sintokogio, Ltd.); Turbo Screener (manufactured by Turbo Kogyo Ltd.); Micro Shifter (manufactured by Makino Sangyo Ltd.); and circular vibration sieves.

Next, the method for measuring the particle size distribution of toner particle related to the present disclosure will be described.

### Measurement of the Particle Size Distribution of Toner

In a “Changing standard operation method (SOM)” screen of the dedicated software, the total count number in the control mode is set to be 50,000 particles, the number of measurements is set to be 1, and a Kd value is set to be a value obtained by using “Standard particle 10.0 μm” (manufactured by Beckman Coulter, Inc.). A threshold value and a noise level are automatically set by pushing a “Threshold value/noise level measurement button”. In addition, Current is set to be 1,600 μA, Gain is set to be 2, Electrolytic aqueous solution is set to be ISOTON II, and “Flush of aperture tube after measurement” is checked,

In a “Setting conversion from pulse to particle size” screen of the dedicated software, Bin interval is set to be logarithmic particle size, Particle size bin is set to be 256 particle size bin, and Particle size range is set to be 2 to 60 μm.

Specific measuring method is as described below.
(1) A 250 mL round-bottom glass beaker dedicated to “Multisizer 3” is charged with about 200 mL of the electrolytic aqueous solution, the beaker is set into a sample stand, and counterclockwise agitation with a stirrer rod is performed at 24 rotations/sec. Subsequently, contamination and air bubbles in the aperture tube are removed by a “Flush of aperture tube” function of the dedicated software.
(2) A 100 mL flat-bottom glass beaker is charged with about 30 mL of the electrolytic aqueous solution. To the beaker, about 0.3 mL of diluted liquid prepared by diluting a dispersing agent “Contaminon N” (10% by mass aqueous solution of neutral detergent for precision measurement appliance cleaning which includes a nonionic surfactant, an anionic surfactant, and an organic builder and which has a pH of 7, manufactured by Wako Pure Chemical Industries, Ltd.) with ion exchanged water by a factor of 3 on a mass basis is added.
(3) An ultrasonic dispersion device “Ultrasonic Dispersion System Tetora 150” (manufactured by Nikkaki Bios Co., Ltd.) that includes two oscillators having an oscillation frequency of 50 kHz, with their phases shifted by 180 degrees from each other, and that has an electrical output of 120 W is prepared, A water tank provided with an ultrasonic dispersion device is charged with a predetermined amount of ion exchanged water, and about 2 mL of Contaminon N above is added to the water tank.
(4) The beaker according to (2) above is set into a beaker fixing hole of the ultrasonic dispersion device, and the ultrasonic dispersion device is operated, Subsequently, the height position of the beaker is adjusted so that the resonance state of the liquid surface of the electrolytic aqueous solution in the beaker becomes at a maximum level.
(5) in a condition in which the electrolytic aqueous solution in the beaker according to (4) above is irradiated with ultrasonic waves, about 10 mg of toner is added gradually to the electrolytic aqueous solution and dispersed. Subsequently, the ultrasonic dispersion treatment is continued for further 60 sec. In this regard, during the ultrasonic dispersion treatment, the water temperature of the water tank is appropriately adjusted to become 10° C. or higher and 40° C. or lower.
(6) The electrolytic aqueous solution, according to (5) above, containing the dispersed toner particle is dripped to the round-bottom beaker, according to (1) above, set into the sample stand by using a pipette so that the measured concentration is adjusted to about 5%. Subsequently, the measurement is performed until the number of measured particle reaches 50,000.
(7) The weight-average particle diameter (D4) is calculated by analyzing the measurement data with the dedicated software attached to the apparatus. In this regard, an “Average diameter” on an “Analysis/volume statistical value (arithmetic mean)” screen, where graph/volume % is set in the dedicated software, corresponds to the weight-average particle diameter (D4).

### Magnetic Carrier

The toner of the present disclosure may be mixed with a carrier and used as a two-components developer. As the carrier, a carrier such as normal ferrite or magnetite or a resin-coated carrier can be used. Also, magnetic dispersion type resin particle in which magnetic powder is dispersed in the resin component or porous magnetic particle containing resin in voids can be used.

As the magnetic material component to be used for, the magnetic dispersion-type resin particle, magnetite particle powder, maghemite particle powder, or magnetic iron oxide particle powder in which at least one kind selected from silicon oxide, silicon hydroxide, aluminum oxide and aluminum hydroxide is contained: magnetoplanbite type ferrite particle powder containing barium, strontium, or barium-strontium: and spinel-type ferrite particle powder containing at least one kind selected from manganese, nickel, zinc, lithium and magnesium can be used.

In addition to the magnetic component, a non-magnetic iron oxide particle powder such as a hematite particle powder, a non-magnetic ferric hydrated particle powder such as a goethite particle powder, titanium oxide particle powder, silica particle powder, talc particle powder, alumina particle powder, barium sulfate particle powder, barium carbonate particle powder, cadmium yellow particle powder, calcium carbonate particle powder, a non-magnetic inorganic compound particle powder such as zinc particle powder may be used in combination with the magnetic iron compound particle powder.

As the material of the porous magnetic core particle, magnetite or ferrite can be mentioned. Specific examples of ferrite are given by the following general formula.

(M1₂O)x(M2O)y(Fe₂O₃)z

In the above formula, M1 is a monovalent metal and M2 is a bivalent metal, where x+y+z=1.0, x and y are 0≤(x, y)≤0.8, respectively, and z is 0.2<z<1.0) in the formula, at least one metal atom selected from the group consisting of Li, Fe, Mn, Mg, Sr, Cu, Zn, Ca is preferably used as M1 and M2. In addition, Ni, Co, Ba, Y, V, Bi, In, Ta, Zr, B, Mo, Na, Sn, Ti, Cr, Al, Si, and rare earths can also be used.

Resin-coated carriers consist of magnetic carrier core particle and a resin coating layer that coats the surface of the magnetic carrier core particle. Examples of resins used for the resin coating layer include acrylic resins such as acrylic ester copolymers and methacrylate copolymers, styrene-acrylic resins such as styrene-acrylic ester copolymers and styrene-methacrylate ester copolymers, fluorine-containing resins such as polytetrafluoroethylene, tetrafluoroethylene hexafluoropropylene copolymers, monochlorotrifluoroethylene polymers and polyvinylidene fluoride, silicone resins, polyester resins, polyamide resins, polyvinyl butyral, aminoacrylate resins, iomonomer resins, and polyphenylene sulfide resins. These resins can be used alone or in combination. Among them, copolymers containing methacrylate ester with an alicyclic hydrocarbon group are particularly preferable from the viewpoint of charging stability.

Examples of the methacrylate ester having the alicyclic hydrocarbon group include cyclobutyl acrylate, cyclopentyl acrylate, cyclohexyl acrylate, cycloheptyl acrylate, dicyciopentenyl acrylate, dicyclopentanyl acrylate, cyclobutyl methacrylate, cyclopentyl methacrylate, cyclopentyl methacrylate, cyclohexyl methacrylate, cycloheptyl methacrylate, dicyclopentenyl methacrylate, and dicyclopentanyl methacrylate. The alicyclic hydrocarbon group is preferably a cycloalkyl group, of which carbon number is preferably 3 to 10, and more preferably 4 to 8. It is possible to use one of these in isolation, or a combination thereof.

Furthermore, from the viewpoint of charging stability, it is preferable that the resin coating layer contains a macromonomer as a copolymerization component in order to enhance the adhesion between the magnetic carrier core particle and the resin coating layer and to suppress local exfoliation of the resin coating layer.

An example of a specific macromonomer is shown in formula (B).

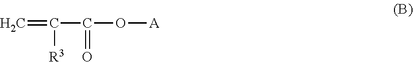

In formula (B), A denotes a polymer containing one or 2 or more compounds as a component to be cured the compounds selected from the group consisting of methyl acrylate, methyl methacrylate, butyl acrylate, butyl methacrylate, 2-ethylhexyl acrylate, 2-ethylhexyl methacrylate, styrene, acrylonitrile, and methacrylonitrile, and R³ denotes H or CH₃.

### EXAMPLES

While the basic structure and features of the present disclosure have been described above, the present disclosure will be specifically described below based on examples. However, the present disclosure is not in any way limited to this. Unless otherwise noted, parts and percentages are mass standards.

### Production Example of Binder Resin 1

| | |
|---|---|
| Bisphenol A propylene oxide (2.2 mol adduct) | 100.0 mol parts |
| Terephthalic acid | 50.0 mol parts |
| Adipic acid | 10.0 mol parts |

For the monomers comprising the above polyester unit, 500 ppm of titanium tetrabutoxide was mixed in a 5 liter autoclave.

The above materials were weighed in a reaction tank with a cooling tube, an agitator, a nitrogen introduction tube, and a thermocouple. The air in the flask was replaced with nitrogen gas, the temperature was gradually raised with stirring, and the reaction was carried out for 2 hours with stirring at a temperature of 200° C.

In addition, the pressure in the reaction tank was lowered to 8.3 kPa and maintained for 1 hour, then cooled to 180° C. and returned to atmospheric pressure (the first reaction step).

| | |
|---|---|
| Trimellitic anhydride | 15.0 mole parts |

Then, the above materials were added, the pressure in the reaction tank was lowered to 8.3 kPa, the reaction was made while maintaining the temperature at 160° C. The reaction time was adjusted to attain the desired molecular weight, and the reaction was stopped by lowering the temperature (the second reaction step) to obtain the binder resin 1. The binder resin 1 had a Tg of 60° C. and an acid value of 20.0 mgKOH/g. Other physical properties are shown in Table 1.

### Production Example of Binder Resin 2-6

The binder resin 2-6 was obtained according to the production example of binder resin 1 except that the type/amount of monomer was chanced as shown in Table 1 and the molecular weight and Tg were changed by adjusting the reaction time. The physical properties of the obtained binder resin 2-6 are shown in Table 1.

### Production Example of Binder Resin 1 Fine Particle Dispersion

| | |
|---|---|
| Tetrahydrofuran (Wako | 300 parts |
| Pure Chemical Co., Ltd.) | |
| Binder resin 1 | 100 parts |
| Anionic surfactant Neogen RK (Daiichi | 0.5 parts |
| Kogyo Pharmaceutical Co., Ltd.) | |

The above materials were weighed, mixed, and dissolved.

Then, 20.0 parts of 1 mol/L ammonia water were added and stirred at 4,000 rpm using an ultra-high-speed stirring device, T.K.Robomix (manufactured by Primix). In addition, 700 parts of ion exchanged water were added at a rate of 8 g/min to deposit binder resin 1 fine particle. Then, tetrahydrofuran was removed using an evaporator, and the concentration was adjusted with ion exchanged water to obtain an aqueous dispersion (binder resin 1 fine particle dispersion) in which the concentration of binder resin 1 fine particle was 20 mass %.

The 50% particle diameter (D50) of the volume distribution standard of the binder resin 1 fine particle was 0.13 μm.

### Production Example of Binder Resin 2-6 Fine Particle Dispersions

In the production example of binder resin 1 fine particle dispersion, binder resin 2-6 fine particle dispersions were obtained in the same manner except that binder resin 1 was changed to binder resin 2-6, respectively.

TABLE 1
List of preparation of resin

| | Preparation | | | | | | | Physical property | | | |
|---|---|---|---|---|---|---|---|---|---|---|---|
| | BPA-EO | BPA-PO | PG | TPA | TMA | AA | FA | | | | |
| | [molar | [molar | [molar | [molar | [molar | [molar | [molar | Tg | Acid value | | |
| No. | parts] | parts] | parts] | parts] | parts] | parts] | parts] | [° C.] | [mgKOH/g] | Mw | Mw/Mn |
| Binder resin 1 | | 100 | | 50 | 15 | 10 | | 60 | 20 | 36000 | 7.6 |
| Binder resin 2 | 40 | 60 | | 50 | 15 | 10 | | 62 | 23 | 26000 | 7.8 |
| Binder resin 3 | | 100 | | 50 | 15 | 10 | 10 | 63 | 20 | 56000 | 10.0 |
| Binder resin 4 | | | 100 | 50 | 10 | 20 | 40 | 59 | 23 | 62000 | 8.3 |
| Binder resin 5 | | 100 | | 50 | 20 | 10 | 10 | 61 | 24 | 24000 | 5.2 |
| Binder resin 6 | 5 | 95 | | 30 | | | 70 | 59 | 21 | 100000 | 16.0 |

BPA-PO Propylene oxide adduct of bisphenol A (average number of moles of added moles 2.2 mol)
BPA-EO Ethylene oxide adduct of bisphenol A (average number of moles of added moles 2.2 mol)
TPA Terephthalic acid
TMA anhydride Trimellitic anhydride
PG Propylene glycol
AA Adipic acid
FA Fumaric acid

### Production Example of Release Agent Line Particle Dispersion

| | |
|---|---|
| Fischer-Tropsch wax, melting point 90° C. | 100 parts |
| Anionic surfactant: Neogen RK | 5 parts |
| (Daiichi Kogyo Pharmaceutical Co., Ltd.) | |
| Ion exchanged water | 395 parts |

The above materials were weighed, put into a mixing vessel with an agitator, heated to 90° C., and circulated to Clear Mix W Motion (manufactured by M Technique) for 60 minutes for dispersion treatment.

The condition for dispersion treatment was as follows.

| | | |
|---|---|---|
| Outer diameter of rotor | 3 | cm |
| Clearance | 0.3 | mm |
| Rotor rotation speed | 19000 | r/min |
| Screen rotation speed | 19000 | r/min |

After the dispersion treatment, an aqueous dispersion with a concentration of a release agent fine particle of 20 mass % (release agent fine particle dispersion) was obtained by cooling to 40° C. under the cooling treatment conditions of 1000 r/min rotor rotation speed, 0 r/min screen rotation speed and 10° C./min cooling rate.

The 50% particle diameter (D50) of the volume distribution standard of the release agent fine particle was measured using a dynamic light scattering particle size distribution meter, Nanotrac UPA-EX150 (manufactured by Nikkiso Co., Ltd,), and it was 0.15 μm.

### Production of Colorant Fine Particle Dispersion

| | |
|---|---|
| Colorant (Magenta pigment: | 50.0 parts |
| Pigment Red 122) | |
| Anionic surfactant Neogen RK | 7.5 parts |
| (Daiichi Kogyo Pharmaceutical Co., Ltd.) | |
| Ion exchanged water | 442.5 parts |

The above materials were weighed, mixed, dissolved, and dispersed using a high-pressure impact disperser Nanomizer (manufactured by Yoshida Kikai Co., Ltd.) for about 1 hour to obtain an aqueous dispersion (colorant fine particle dispersion) with a colorant fine particle concentration of 10 mass %.

The 50% particle diameter (D50) of the volume distribution standard of the colorant fine particle was measured using a dynamic light scattering particle size distribution meter, Nanotrac UPA-EX150 (manufactured by Nikkiso Co., Ltd.), and it was 0.20 μm.

### Production Example of Toner Particle

### (Production Example of Toner Particle 1)

| | |
|---|---|
| Binder resin 1 fine | 100 parts (as an amount of |
| particle dispersion | the binder resin) |
| Release agent fine | 5 parts (as an amount of |
| particle dispersion | the release agent) |
| Colorant fine particle | 5 parts (as an amount of |
| dispersion | the colorant) |
| Ion exchanged water | 160 parts |

The above materials were put into a round stainless steel flask, mixed, and then an aqueous solution of 0.25 parts aluminum chloride dissolved in 10 parts ion exchanged water was added. Subsequently, the mixture was objected to dispersion at 5000 r/min for 10 minutes using a homogenizer Ultra-turrax T50 manufactured by IKA corporation). The mixture was then heated in a heating water bath to 58° C. using a stirring blade while adjusting the rotation speed at which the mixture was stirred appropriately.

Using Coulter Multisizer III, the volume-average particle size of the formed aggregated particle was checked as appropriate, and when aggregated particle with a volume-average particle diameter of about 6.5 μm were formed, 100 parts of a 5% aqueous solution of sodium ethylenediamine tetraacetate was added, and the mixture was heated to 75° C. while continuing stirring. The aggregated particle were then fused by holding at 75° C. for 1 hour. Crystallization of the polymer was promoted by cooling to 50° C. and held for 3 hours.

Then, as a step of removing the polyvalent metal ions from the aggregation agent, the product was washed with 5% aqueous sodium ethylenediaminetetraacetate solution while being kept at 50° C.

Then, the product was cooled to 25° C., filtered and separated into solid and liquid, and the product was washed with ion exchanged water to prepare a product. After washing the product, the product was dried using a vacuum dryer to obtain toner particle 1 with a weight-average particle diameter (D4) of about 6.5 μm.

### (Production Example of Toner Particles 2 and 4-24)

Toner particles 2 and 4-24 were obtained by the same operation as in the production example of toner particle 1 except that the type and amount of binder resin 1 fine particle dispersion, the type and amount of aggregation agent, the type of remover, and the addition temperature of the remover were changed as shown in Table 2,

Note that the “number of additions” of polyvalent metals in Table 2 is the amount of each compound added, except for toner particle 3: Al denotes added amount of aluminum chloride, Mg denotes added amount of magnesium chloride, Zn denotes added amount of zinc chloride, Fe denotes added amount of iron chloride, and Ca denotes added amount of calcium chloride.

### (Production Example of Toner Particle 3)

| | | |
|---|---|---|
| Binder resin 1 | 100 | parts |
| Fischer-Tropsch wax (melting point 90° C.) | 5 | parts |
| Pigment Red 122 | 5 | parts |
| Aluminum 3,5-di-t-butylsalicylate compound | 2.9 × 10⁻⁸ | parts |
| Sodium ethylenediamine tetraacetate | 9.2 × 10⁻⁸ | parts |

The above materials were mixed in a Henschel mixer (FM-75, manufactured by Japan Coke Industries, Ltd.) at a rotation speed of 20 s⁻¹ and a rotation time of 5 min, and then kneaded in a biaxial mixer (PCM Type-30, manufactured by Ikegai Co., Ltd.) set at a temperature of 120° C. and a screw rotation speed of 200 rpm at a discharge temperature of 135° C. The resulting kneaded material was cooled at a cooling rate of 15° C./min, and coarsely pulverized to 1 mm or less in a hammer mill to obtain coarse crumbs. The obtained coarsely pulverized product were finely pulverized in a mechanical pulverizi (T-250, manufactured by Freund Turbo Co., Ltd.).

Further, classification was performed using Facarty F-300 (Hosokawa Micron) to obtain toner particle 3. The operating conditions were 130 s⁻¹ for the classification rotor rotation speed and 120 s⁻¹ for the dispersion rotor rotation speed.

TABLE 2

| | | | | | | | | | | | Content | | | Content |
|---|---|---|---|---|---|---|---|---|---|---|---|---|---|---|
| | Binder resin | | Colorant | | Wax | | Polyvalent metal | | | | of | | | ration |
| | | Parts | | Parts | | Parts | | Parts | | | poly- | | Weight- | of |
| Toner | Binder | added | Name | added | Name | added | | added | | | valent | | average | mono- |
| particle | resin | (mass | of | (mass | of | (mass | | (mass | Monovalent metal | | metal | | particle | valent |
| No. | No. | parts) | compound | parts) | compound | parts) | Kind | parts) | | Temperature | (μmol | Prep- | size | metal |
| | | | | | | | | | Kind | (° C.) | /g) | aration | (μm) | (%) |
| Toner | Binder | 100 | PR122 | 5 | Fischer- | 5 | Al | 0.25 | Na | 50 | 0.23 | Emulsion | 6.5 | 61.0 |
| particle | resin 1 | | | | Tropsch, | | | | | | | ag- | | |
| 1 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | 5 | Al | 0.25 | Na | 70 | 0.23 | Emulsion | 6.5 | 63.0 |
| particle | resin 1 | | | | Tropsch, | | | | | | | ag- | | |
| 2 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 2.9 × | Na | 120 | 0.23 | Melt | 6.5 | 60.0 |
| particle | resin 1 | | | | Tropsch, | | | 10⁻⁸ | | | | mixing | | |
| 3 | | | | | melting | | | | | | | | | |
| | | | | | point | | | | | | | | | |
| | | | | | 90° C. | | | | | | | | | |
| Toner | Binder | 100 | PR122 | 5 | Fischer- | | Mg | 0.25 | Na | 70 | 0.52 | Emulsion | 6.5 | 55.0 |
| particle | resin 1 | | | | Tropsch, | | | | | | | ag- | | |
| 4 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Zn | 0.25 | Na | 70 | 0.61 | Emulsion | 6.5 | 80.0 |
| particle | resin 1 | | | | Tropsch, | | | | | | | ag- | | |
| 5 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Fe | 0.25 | Na | 70 | 0.75 | Emulsion | 6.5 | 50.0 |
| particle | resin 1 | | | | Tropsch, | | | | | | | ag- | | |
| 6 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Ca | 0.25 | Na | 70 | 0.81 | Emulsion | 6.5 | 60.0 |
| particle | resin 1 | | | | Tropsch | | | | | | | ag- | | |
| 7 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 1.30 | Na | 70 | 1.20 | Emulsion | 6.5 | 90.0 |
| particle | resin 1 | | | | Tropsch, | | | | | | | ag- | | |
| 8 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 1.70 | | 70 | 1.60 | Emulsion | 6.5 | 50.0 |
| particle | resin 1 | | | | Tropsch, | | | | | | | ag- | | |
| 9 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 2.30 | K | 70 | 2.20 | Emulsion | 6.5 | 50.0 |
| particle | resin 1 | | | | Tropsch, | | | | | | | ag- | | |
| 10 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 2.50 | Na | 70 | 2.40 | Emulsion | 6.5 | 30.0 |
| particie | resin 1 | | | | Tropsch, | | | | | | | ag- | | |
| 11 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.25 | Na | 70 | 0.23 | Emulsion | 6.5 | 30.0 |
| particle | resin 1 | | | | Tropsch, | | | | | | | ag- | | |
| 12 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.25 | Na | 70 | 0.23 | Emulsion | 6.5 | 30.0 |
| particie | resin 2 | | | | Tropsch, | | | | | | | ag- | | |
| 13 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.25 | Na | 70 | 0.23 | Emulsion | 6.5 | 30.0 |
| particle | resin 3 | | | | Tropsch, | | | | | | | ag- | | |
| 14 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.16 | Na | 30 | 0.15 | Emulsion | 6.5 | 30.0 |
| particle | resin 4 | | | | Tropsch, | | | | | | | ag- | | |
| 15 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.30 | Na | 30 | 0.28 | Emulsion | 6.5 | 30.0 |
| particle | resin 5 | | | | Tropsch, | | | | | | | ag- | | |
| 16 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.08 | Na | 30 | 0.10 | Emulsion | 6.5 | 30.0 |
| particle | resin 6 | | | | Tropsch, | | | | | | | ag- | | |
| 17 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.35 | Na | 30 | 0.32 | Emulsion | 6.5 | 30.0 |
| particie | resin 6 | | | | Tropsch, | | | | | | | ag- | | |
| 18 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.55 | Na | 30 | 0.50 | Emulsion | 6.5 | 30.0 |
| particle | resin 6 | | | | Tropsch, | | | | | | | ag- | | |
| 19 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.55 | Na | 30 | 0.50 | Emulsion | 6.5 | 30.0 |
| particle | resin 6 | | | | Tropsch, | | | | | | | ag- | | |
| 20 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.55 | None | | 0.50 | Emulsion | 6.5 | 30.0 |
| particle | resin 6 | | | | Tropsch, | | | | | | | ag- | | |
| 21 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | None | | Na | 50 | 0 | Emulsion | 6.5 | 61.0 |
| particle | resin 1 | | | | Tropsch, | | | | | | | ag- | | |
| 22 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.25 | Na | 50 | 0.23 | Emulsion | 6.5 | 61.0 |
| particle | resin 1 | | | | Tropsch, | | | | | | | ag- | | |
| 23 | | | | | melting | | | | | | | gregation | | |
| | | | | | point | | | | | | | | | |
| | | | | | 90° C. | | | | | | | | | |
| Toner | Binder | 100 | PR122 | 5 | Fischer- | | Al | 0.25 | Na | 50 | 0.23 | Emulsion | 6.5 | 61.0 |
| particle | resin 1 | | | | Tropsch, | | | | | | | ag- | | |
| 24 | | | | | melting | | | | | | | gregation | | |
| | | | | | point | | | | | | | | | |
| | | | | | 90° C. | | | | | | | | | |

### Production Example of Silica Fine Particle 1

100 g of fumed silica (silica fine particle base: spherical) with the number-average particle diameter of 120 nm was placed in a reaction vessel made of stainless steel (SUS304) to which a vacuum pump was connected, and the inside of the reaction vessel was depressurized to 0.001 Pa, heated and stirred, and controlled for the temperature of the reaction vessel to become 330° C.

After deaeration for 30 minutes in this state, octamethylcyclotetrasiloxane vapor was introduced as a surface treatment agent, and the pressure in the reaction vessel was controlled to be 1 Pa by adjusting the opening of the valve between the vacuum pump and the reaction vessel while supplying at 15 g/min for 10 minutes. After supplying octyltrisiloxane vapor, the surface of the silica fine particle substrate was treated by heating and stirring for 40 minutes.

Then, in order to remove the reaction products and the unreacted surface treatment agent, the inside of the reaction vessel was evacuated under reduced pressure to 0.001 Pa to obtain silica fine particle 1. The physical properties of the obtained silica fine particles are shown in Table 3.

### Production Example of Silica Fine Particles 2-13

The production of silica fine particles 2-13 was performed in the same manner as for silica fine particle 1, except that the treatment agent and treatment conditions were changed as shown in Table 3 for fumed silica (silica fine particle source: spherical) with the number-average particle diameter as shown in Table 3.

TABLE 3
List of preparation of silica particle

| | | | | | | | | | | | | | Amount | Structure |
|---|---|---|---|---|---|---|---|---|---|---|---|---|---|---|
| | | | | | Supplying | Supplying | | | | | | | of | of |
| | | | | | rate | time | | | | | | | treat- | treat- |
| | | Particle | | Type | of | of | Treat- | | | | | | ment | ment |
| Name | | diameter | | of | treat- | treat- | ment | Reaction | | | | | (SD1 + | agent |
| of | Type | of | Substrate | treat- | ment | ment | agent | tem- | Reaction | | | | SD2)/ | (SD1 + |
| com- | of | substrate | [parts | ment | agent | agent | [parts | perature | time | | | | SQ × | SD2)/ |
| pound | substrate | [nm] | added] | agent | [g/min] | [min] | added] | [° C.] | [min] | SQ | SD1 | SD2 | 100 | SD1 |
| Silica | Silica | 120.0 | 100.0 | D4 | 15.0 | 10.0 | 150 | 330 | 180 | 182.3 | 5.8 | 7.2 | 7.1 | 2.2 |
| 1 | | | | | | | | | | | | | | |
| Silica | Silica | 300.0 | 100.0 | D4 | 15.0 | 5.0 | 75 | 330 | 120 | 204.2 | 3.5 | 5.2 | 4.3 | 2.5 |
| 2 | | | | | | | | | | | | | | |
| Silica | Silica | 80.0 | 100.0 | D4 | 15.0 | 13.0 | 195 | 300 | 120 | 152.3 | 6.0 | 9.5 | 10.2 | 2.6 |
| 3 | | | | | | | | | | | | | | |
| Silica | Silica | 40.0 | 100.0 | D3 | 15.0 | 15.0 | 225 | 330 | 120 | 142.1 | 9.3 | 12.9 | 15.6 | 2.4 |
| 4 | | | | | | | | | | | | | | |
| Silica | Silica | 500.0 | 100.0 | D3 | 15.0 | 3.0 | 45 | 330 | 120 | 190.4 | 2.4 | 4.3 | 3.5 | 2.8 |
| 5 | | | | | | | | | | | | | | |
| Silica | Silica | 120.0 | 100.0 | D3 | 15.0 | 10.0 | 150 | 330 | 120 | 170.4 | 5.3 | 9.0 | 8.4 | 2.7 |
| 6 | | | | | | | | | | | | | | |
| Silica | Silica | 120.0 | 100.0 | D4 | 15.0 | 10.0 | 150 | 300 | 120 | 191.3 | 5.1 | 13.1 | 9.5 | 3.6 |
| 7 | | | | | | | | | | | | | | |
| Silica | Silica | 120.0 | 100.0 | D6 | 15.0 | 3.0 | 45 | 330 | 60 | 194.5 | 1.1 | 5.3 | 3.3 | 5.9 |
| 8 | | | | | | | | | | | | | | |
| Silica | Silica | 120.0 | 100.0 | D6 | 10.0 | 1.0 | 10 | 330 | 30 | 185.3 | 0.6 | 3.2 | 2.1 | 6.3 |
| 9 | | | | | | | | | | | | | | |
| Silica | Silica | 120.0 | 100.0 | PDMS | 10.0 | 1.0 | 10 | 330 | 120 | 192.3 | 0.3 | 2.0 | 1.2 | 7.7 |
| 10 | | | | | | | | | | | | | | |
| Silica | Silica | 120.0 | 100.0 | PDMS | 5.0 | 1.0 | 5 | 310 | 120 | 187.4 | 0.2 | 1.5 | 0.9 | 9.3 |
| 11 | | | | | | | | | | | | | | |
| Silica | Silica | 10.0 | 100.0 | D4 | 15.0 | 10.0 | 150 | 330 | 180 | 182.3 | 5.8 | 7.2 | 7.1 | 2.2 |
| 12 | | | | | | | | | | | | | | |
| Silica | Silica | 120.0 | 100.0 | PDMS | 5.0 | 1.0 | 5 | 270 | 120 | 175.3 | 0.15 | 1.8 | 1.1 | 13.0 |
| 13 | | | | | | | | | | | | | | |

D3 Hexamethylcyclotrisiloxane
D4 Octamethylcyclosiloxane
D6 Dodecamethylcyclohexane
PDMS Polydimethylsiloxane

### Production Example of Toner Production

### (Production Example of Toner 1 Production)

| | |
|---|---|
| Toner particle 1 | 100 parts |
| Silica 1 | 5 parts |

Toner I was obtained by mixing the above materials in a Henschel mixer type FM-10 C (manufactured by Mitsui Miike Kako Co., Ltd.) at a rotation speed of 30 s⁻¹ and a rotation time of 10 min.

### (Production Example of Toners 2-24)

Toners 2-24 were manufactured for toner particles 2-24 in the same manner as the production example of toner 1, except that silica to be externally added is the combination and the amount of addition shown in Table 4.

TABLE 4

| | | Externally | |
|---|---|---|---|
| | | added particle | |
| Toner | Toner | Name of | Parts added |
| No. | particle No. | compound | (mass parts) |
| Toner 1 | Toner particle 1 | Silica 1 | 5 |
| Toner 2 | Toner particle 2 | Silica 1 | 5 |
| Toner 3 | Toner particle 3 | Silica 1 | 5 |
| Toner 4 | Toner particle 4 | Silica 1 | 5 |
| Toner 5 | Toner particle 5 | Silica 1 | 5 |
| Toner 6 | Toner particle 6 | Silica 1 | 5 |
| Toner 7 | Toner particle 7 | Silica 1 | 5 |
| Toner 8 | Toner particle 8 | Silica 2 | 5 |
| Toner 9 | Toner particle 9 | Silica 3 | 5 |
| Toner 10 | Toner particle 10 | Silica 4 | 5 |
| Toner 11 | Toner particle 11 | Silica 5 | 1 |
| Toner 12 | Toner particle 12 | Silica 1 | 8 |
| Toner 13 | Toner particle 13 | Silica 6 | 0.01 |
| Toner 14 | Toner particle 14 | Silica 7 | 10 |
| Toner 15 | Toner particle 15 | Silica 1 | 15 |
| Toner 16 | Toner particle 16 | Silica 1 | 15 |
| Toner 17 | Toner particle 17 | Silica 1 | 15 |
| Toner 18 | Toner particle 18 | Silica 8 | 15 |
| Toner 19 | Toner particle 19 | Silica 9 | 15 |
| Toner 20 | Toner particle 20 | Silica 10 | 15 |
| Toner 21 | Toner particle 21 | Silica 11 | 15 |
| Toner 22 | Toner particle 22 | Silica 1 | 5 |
| Toner 23 | Toner particle 23 | Silica 12 | 5 |
| Toner 24 | Toner particle 24 | Silica 13 | 5 |

### Production Example of Magnetic Carrier Core Particle 1

### Step 1 (Weighing and Mixing Step)

| | |
|---|---|
| Fe₂O₃ | 68.3 mass % |
| MnCO₃ | 28.5 mass % |
| Mg(OH)₂ | 2.0 mass % |
| SrCO₃ | 1.2 mass % |

The above ferrite raw materials were weighed, 20 parts of water were added to 80 parts of the ferrite raw materials, and then the slurry was prepared by wet mixing for 3 hours in a ball mill using zirconia with a diameter (φ) of 10 mm.

The concentration of solids in the slurry was 80 mass %.

### Step 2 (Tentative-Calcination Step)

The mixed slurry was dried with a spray dryer (manufactured by Okawara Kako Co., Ltd.) and then calcined in a batch type electric furnace under a nitrogen atmosphere (oxygen concentration of 1.0 vol %) at a temperature of 1050° C. for 3.0 hours to produce an tentative-calcined ferrite.

### Step 3 (Pulverizing Step)

After the tentative-calcined ferrite was pulverized to about 0.5 mm by a crusher, water was added to prepare the slurry. The solid concentration of the slurry was adjusted to 70 mass %. The obtained object was pulverizing for 3 hours in a wet ball mill using ⅛ inch stainless steel beads to obtain a slurry. The slurry was further pulverized for 4 hours in a wet bead mill using 1 mm diameter beads of zirconia to obtain a tentative-calcined ferrite slurry with 50% particle diameter (D50) by volume base of 1.3 μm.

### Step 4 (Granulation Step)

To 100 parts of the above tentative-calcined ferrite slurry, 1.0 parts of ammonium polycarboxylate as a dispersant and 1.5 parts of polyvinyl alcohol as a binder were added and then granulated and dried into spherical particles with a spray dryer (manufactured by Okawara Kako Co., Ltd.). The particle size of the obtained granule was adjusted and the granule was heated at 700° C. for 2 hours in a rotary electric furnace to remove organic substance such as dispersants and binders.

### Step 5 (Calcination Step)

Calcination was conducted under a nitrogen atmosphere (oxygen concentration of 1.0 volume %), with setting the time from room temperature to the calcination temperature (1100° C.) to 2 hours, held at 1100° C. for 4 hours. The temperature was then lowered to 60° C. over 8 hours, returned to the atmosphere from the nitrogen atmosphere, and the obtained object was taken out at a temperature below 40° C.

### Step 6 (Selection Step)

After the aggregated particle were crushed, coarse particle were removed by sieving with a sieve with a mesh opening of 150 μm, fine particle were removed by performing wind classification, and particle with low magnetic force were further removed by magnetic sorting to obtain porous magnetic core particle.

### Step 7 (Filling Step)

Porous magnetic core particle 100 parts was placed in an agitation vessel of a. mixing agitator (NDMV type universal agitator manufactured by Dalton corporation), and 5 parts of a filling resin consisting of 95.0 mass % methyl silicone oligomer and 5.0 mass % gamma-aminopropyl trimethoxysilane were dropped at atmospheric pressure while maintaining the temperature at 60° C.

After dropping, stirring was continued while adjusting time, the temperature was raised to 70° C., and each of the particles of the porous magnetic core particle were filled with the resin composition.

After cooling, the Obtained resin-tilled magnetic core particle was transferred to a mixer (UD-AT type drum mixer manufactured by Sugiyama Heavy Industries, Ltd.) having spiral blades in a rotatable mixing vessel, and the temperature was raised to 140° C. at a rate of 2° C. per minute while stirring under a nitrogen atmosphere. Heating and stirring was then continued at 140° C. for 50 minutes.

It was then cooled to room temperature, ferrite particle filled with resin and cured were taken out, and the non-magnetic material was removed using a magnetic separation machine. Furthermore, coarse particle were removed with a vibrating sieve to obtain magnetic carrier core particle 1 filled with resin.

### (Production Example of Coating Resin)

| | |
|---|---|
| Cyclohexyl methacrylate monomer | 26.8% |
| Methyl methacrylate monomer | 0.2% |
| Methyl methacrylate macromonomer | 8.4% |
| (a macromonomer having a methacryloyl | |
| group at one end with a weight-average | |
| molecular weight of 5000) | |
| Toluene | 31.3% |
| Methyl ethyl ketone | 31.3% |
| Azobisisobutyronitrile | 2.0% |

Of the above materials, cyclohexyl methacrylate monomer, methyl methacrylate monomer, methyl methacrylate macromonomer, toluene, and methyl ethyl ketone were placed in a four-port separable flask attached with a reflux condenser, thermometer, nitrogen introduction tube, and stirring device. Nitrogen gas was introduced into the separable flask to bring it to a sufficient nitrogen atmosphere, then it was warmed to 80° C., azobisisobutyronitrile was added, and the mixture was refluxed for 5 hours for polymerization.

The resulting reactant was injected with hexane to precipitate the copolymers.

The resulting precipitate was filtered and then vacuum-dried to obtain resin.

30 parts of the resin were dissolved in a mixed solvent of 40 parts of toluene and 30 parts of methyl ethyl ketone to obtain a resin solution (30% solid concentration).

### (Preparation of Coating Resin Solution)

| | |
|---|---|
| Resin solution (solid concentration 30% ) | 33.3% |
| Toluene | 66.4% |
| Carbon black (Regal330; Cabot) | 0.3% |

(Number-average particle diameter of a primary particle: 25 nm, Nitrogen adsorption specific surface area: 94 m²/g, DBP oil absorption: 75 ml/100 g)

The above materials were placed in a paint shaker and dispersed for 1 hour using 0.5 mm diameter zirconia beads. The resulting dispersion was filtered through a 5.0 μm membrane filter to obtain a coating resin solution.

### (Production Example of Magnetic Carrier 1)

A coating resin solution and magnetic core particle 1 were charged into a vacuum degassing kneader maintained at room temperature (the charged amount of coating resin solution was 2.5 parts as resin component with respect to 100 parts of magnetic core particle).

After charging, the mixture was stirred at a rotation speed of 30 rpm for 15 minutes, the solvent was volatilized to a certain level (80%), and then the mixture was heated to 80° C. while mixing under reduced pressure for 2 hours to evaporate the toluene, and then cooled.

The obtained magnetic carriers were sorted by magnetic separation, passed through a sieve with an opening of 70 μmn, and classified by a wind classifier to obtain magnetic carrier 1 with a 50% particle diameter by volume distribution base (D50) of 38.2 μm.

### Production Example of Two-Component Developer 1

Ten parts of toner 1 and 90 parts of magnetic carrier 1 were mixed with a V-type mixer (Type V-10: Tolaiju Seisakusho Co., Ltd.) for 0.5 s⁻¹ and a rotation time of 5 min to prepare two-component developer 1.

### Production Example of Two-Component Developer 2-24

Two-component developers 2-24 were obtained in the same manner as the production example of developer 1 except that the toner was changed as shown in Table 5.

### Examples 1-21, Comparative Examples 1-3

The obtained two-component developers were evaluated as follows.

### Evaluation of Scratch Peeling Resistance (1.00 gf)

Scratch peeling resistance was evaluated as follows. Under a low temperature and low humidity environment (L/L: 5° C., 5% RH), an entire area solid image (a toner image formed over the entire area of the image forming portion of photoreceptor drum when the image ratio (printing ratio) is 100%) was output with the loaded amount of toner of 0.9 mg/cm², and the resulting image was evaluated as follows. Mirror-coated P (209.0 g/m² paper) was used as the evaluation paper.
Measuring instrument: HEIDON tribology tester,
Test needle: diameter 0.075 mm, and
Measuring conditions: 60 mm/min, 30 mm, 100 gf load.

Under the above conditions, scratch peeling of the entire area solid image was evaluated. The evaluation was performed by quantifying the area of the peeling area.

### (Evaluation Criteria)

A: Image peeling rate is 5.0% or less,
B: Image peeling rate is over 5.0% and 10.0% or less,
C: Image peeling rate is over 10.0% and 15.0% or less, and
D: Image peeling rate is over 15.0%.

### Evaluation of Scratch Resistance (50 gf)

Scratch peeling resistance was evaluated as follows. Under a low temperature and low humidity environment (L/L: 5° C., 5% RH), an entire area solid image (a toner image formed over the entire area of the image thrilling portion of photoreceptor drum when the image ratio (printing ratio) is 100%) was output with the loaded amount of toner of 0.9 mg/cm², and the resulting image was evaluated as follows.
Mirror-coated P (209.0 g/m² paper) was used as the evaluation paper.
Measuring instrument: HEIDON tribology tester,
Test needle: diameter 0.075 mm, and
Measuring conditions: 60 mm/min, 30 mm, 50 gf load.

Under the above conditions, scratch peeling of the entire area solid image was evaluated.

The evaluation was performed by digitalizing the area of the peeled area.

### (Evaluation Criteria)

A: Image peeling rate is 1.0% or less,
B: Image peeling rate is over 1.0% and 3.0% or less,
C: Image peeling rate is over 3.0% and 5.0% or less, and
D: Image peeling rate is over 5.0%.

### Evaluation of Environmental Stability

The evaluation of environmental stability was performed as follow. Using an on-demand printer, imagePRESS C10010VP (manufactured by Canon Inc.), under the following conditions, ΔE1 (2 weeks), the color difference between the last image A after the load of 100,000 images and the first image B after leaving for another 2 weeks, and ΔE2 (100) the color difference between the last image A after the load of 100,000 images and the 100th image C after leaving for another 2 weeks are evaluated.

### Load Conditions

Paper: GF-C081 (A3, weight 81.4 g/m², commercialized by Canon Marketing Japan Inc.)
Image: 50% duty image solid (the developing voltage was initially adjusted so that the loaded amount of toner on the FFh image was 0.45 mg/cm². FFh is the value of 256 gradations expressed as 16 a decimal number, where 00H is the first gradation (white) and FFh is the 256 gradations (solid).)
Environment: High temperature and high humidity (30° C./80% RH)

### (Evaluation Criteria for Color Difference Between Image A and Image B)

A: ΔE1 (2 weeks) is 5.0 or less,
B: ΔE1 (2 weeks) is more than 5.0 and 9.0 or less,
C: ΔE1 (2 weeks) is more than 9.0 and 12.0 or less, and
D: ΔE1 (2 weeks) is more than 12.0.

### (Evaluation Criteria for Color Difference Between Image A and Image C)

A: ΔE2 (100) is 3.0 or less,
B: ΔE2 (100) is more than 3.0 and 7.0 or less,
C: ΔE2 (100) is more than 7.0 and 10.0 or less, and
D: ΔE2 (100) is 10.0 or more.

### Evaluation of Hot Offset Resistance

Paper: GF-C081 (A3, weight 81.4 g/m², commercialized by Canon Marketing Japan Inc.)
Loaded amount of toner on paper: 0.10 mg/cm²

### (Adjusted by DC Voltage VDC of the Developer Carrier, Charging Voltage VD of the Electrophotographic Photoreceptor, and Laser Power)

Evaluation image: an image of 2 cm×5 cm placed in 1 cm from the end of the above A3 paper into the center direction.
Test environment: normal temperature, low humidity: temperature 23° C./humidity 5% RH (“N/L”)
Process speed: 100 pages of A4 single side per minute

Under the above conditions, the fixing temperature of imagePRESS C10010VP was increased by 5° C. in order from 150° C. (maximum temperature: 210° C.), and the upper limit temperature at which no offset occurred was defined as the hot offset resistant temperature (fixable temperature).

The part where the fixing belt touched by the evaluation image touches the paper again was measured by the mold density meter, and the temperature at which the value of the mold density meter increased by 0,5 with respect to the white ground was set as the temperature of hot offset occurrence temperature.

### (Evaluation Criteria)

A: Fixable temperature is 210° C. or more,
B: Fixable temperature is less than 210° C. and 200° C. or more,
C: Fixable temperature is less than 200° C. and 190° C. or more, and
D: Fixable temperature is less than 190° C.

The results of these evaluations are shown in Table 5.

TABLE 5

| | | | | | | | Environmental | | | | Evaluation | |
|---|---|---|---|---|---|---|---|---|---|---|---|---|
| | | | Eval- | | Eval- | | stability (being | | Environmental | | of | |
| | Tow- | | uation of | | uation of | | left for | | stability (100 | | hot offset | |
| | com- | | scratch | | scratch | | 2 weeks | | copies after being | | resistance | |
| | ponents | | resistance | | resistance | | after 10\hat{ }5 | | left for | | | Temperature |
| | de- | | 100 gf | | 50 gf | | copies) | | 2 week) | | | of |
| | vel- | | | Image | | Image | | ΔΕ1 | | Δ | | Hot offset |
| | oper | Toner | Eval- | peeling | Eval- | peeling | Eval- | (2 | Eval- | E2 | Eval- | occurrence |
| | No. | No. | uation | index | uation | index | uation | week) | uation | (100) | uation | ° C. |
| Ex- | De- | Toner | A | 3.1 | A | 0.2 | A | 3.1 | A | 2.1 | A | 210< |
| am- | vel- | 1 | | | | | | | | | | |
| ple | oper | | | | | | | | | | | |
| 1 | 1 | | | | | | | | | | | |
| Ex- | De- | Toner | A | 3.5 | A | 0.2 | A | 3.2 | A | 2.1 | A | 210< |
| am- | vel- | 2 | | | | | | | | | | |
| ple | oper | | | | | | | | | | | |
| 2 | 2 | | | | | | | | | | | |
| Ex- | De- | Toner | A | 4.2 | A | 0.2 | A | 3.3 | A | 2.3 | A | 210< |
| am- | vel- | 3 | | | | | | | | | | |
| ple | oper | | | | | | | | | | | |
| 3 | 3 | | | | | | | | | | | |
| Ex- | De- | Toner | B | 5.8 | A | 0.4 | A | 3.8 | A | 2.5 | A | 210< |
| am- | vel- | 4 | | | | | | | | | | |
| ple | oper | | | | | | | | | | | |
| 4 | 4 | | | | | | | | | | | |
| Ex- | De- | Toner | B | 5.9 | A | 0.4 | A | 3.9 | A | 2.6 | A | 210< |
| am- | vel- | 5 | | | | | | | | | | |
| ple | oper | | | | | | | | | | | |
| 5 | 5 | | | | | | | | | | | |
| Ex- | De- | Toner | B | 5.9 | A | 0.4 | A | 3.7 | A | 2.7 | A | 210< |
| am- | vel- | 6 | | | | | | | | | | |
| ple | oper | | | | | | | | | | | |
| 6 | 6 | | | | | | | | | | | |
| Ex- | De- | Toner | B | 6.0 | A | 0.4 | A | 3.9 | A | 2.7 | A | 210< |
| am- | vel- | 7 | | | | | | | | | | |
| ple | oper | | | | | | | | | | | |
| 7 | 7 | | | | | | | | | | | |
| Ex- | De- | Toner | B | 6.3 | A | 0.5 | B | 6.2 | | 2.8 | A | 210< |
| am- | vel- | 8 | | | | | | | | | | |
| ple | oper | | | | | | | | | | | |
| 8 | 8 | | | | | | | | | | | |
| Ex- | De- | Toner | B | 6.4 | A | 0.5 | B | 6.3 | A | 2.8 | A | 210< |
| am- | vel- | 9 | | | | | | | | | | |
| ple | oper | | | | | | | | | | | |
| 9 | 9 | | | | | | | | | | | |
| Ex- | De- | Toner | B | 6.4 | A | 0.5 | B | 6.4 | A | 2.9 | A | 210< |
| am- | vel- | 10 | | | | | | | | | | |
| ple | oper | | | | | | | | | | | |
| 10 | 10 | | | | | | | | | | | |
| Ex- | De- | Toner | B | 7.4 | A | 0.6 | B | 6.5 | B | 5.2 | A | 210< |
| am- | vel- | 11 | | | | | | | | | | |
| ple | oper | | | | | | | | | | | |
| 11 | 11 | | | | | | | | | | | |
| Ex- | De- | Toner | B | 7.2 | A | 0.6 | B | 6.7 | B | 5.3 | A | 210< |
| am- | vel | 12 | | | | | | | | | | |
| ple | oper- | | | | | | | | | | | |
| 12 | 12 | | | | | | | | | | | |
| Ex- | De- | Toner | B | 7.3 | A | 0.6 | B | 6.8 | B | 5.4 | A | 210< |
| am- | vel- | 13 | | | | | | | | | | |
| ple | oper | | | | | | | | | | | |
| 13 | 13 | | | | | | | | | | | |
| Ex- | De- | Toner | B | 7.8 | A | 0.6 | B | 6.9 | B | 5.6 | A | 210< |
| am- | vel- | 14 | | | | | | | | | | |
| ple | oper | | | | | | | | | | | |
| 14 | 14 | | | | | | | | | | | |
| Ex- | De- | Toner | B | 8.3 | B | 2.1 | B | 8.2 | B | 6.4 | A | 210< |
| am- | vel- | 15 | | | | | | | | | | |
| ple | oper | | | | | | | | | | | |
| 15 | 15 | | | | | | | | | | | |
| Ex- | De- | Toner | B | 8.5 | B | 2.3 | B | 8.3 | B | 6.5 | A | 210< |
| am- | vel- | 16 | | | | | | | | | | |
| ple | oper | | | | | | | | | | | |
| 16 | 16 | | | | | | | | | | | |
| Ex- | De- | Toner | B | 8.4 | B | 2.5 | B | 8.5 | B | 6.7 | B | 205 |
| am- | vel- | 17 | | | | | | | | | | |
| ple | oper | | | | | | | | | | | |
| 17 | 17 | | | | | | | | | | | |
| Ex- | De- | Toner | B | 8.6 | B | 2.6 | B | 8.2 | B | 6.8 | B | 205 |
| am- | vel- | 18 | | | | | | | | | | |
| ple | oper | | | | | | | | | | | |
| 18 | 18 | | | | | | | | | | | |
| Ex- | De- | Toner | B | 9.5 | B | 2.7 | C | 10.4 | B | 6.4 | B | 205 |
| am- | vel- | 19 | | | | | | | | | | |
| ple | oper | | | | | | | | | | | |
| 19 | 19 | | | | | | | | | | | |
| Ex- | De- | Toner | B | 9.6 | B | 2.5 | C | 10.3 | B | 6.3 | B | 200 |
| am- | vel- | 20 | | | | | | | | | | |
| ple | oper | | | | | | | | | | | |
| 20 | 20 | | | | | | | | | | | |
| Ex- | De- | Toner | B | 9.7 | B | 2.4 | C | 11.2 | C | 8.2 | B | 200 |
| am- | vel- | 21 | | | | | | | | | | |
| ple | oper | | | | | | | | | | | |
| 21 | 21 | | | | | | | | | | | |
| Com- | De- | Toner | C | 12.4 | C | 4.2 | C | 11.5 | D | 13.2 | C | 190 |
| parative | vel- | 22 | | | | | | | | | | |
| example | oper | | | | | | | | | | | |
| 1 | 22 | | | | | | | | | | | |
| Com- | De- | Toner | C | 12.6 | D | 6.7 | C | 11.3 | C | 9.1 | B | 200 |
| parative | vel- | 23 | | | | | | | | | | |
| example | oper | | | | | | | | | | | |
| 2 | 23 | | | | | | | | | | | |
| Com- | De- | Toner | D | 16.2 | D | 6.3 | C | 11.7 | C | 9.2 | C | 190 |
| parative | vel- | 24 | | | | | | | | | | |
| example | oper | | | | | | | | | | | |
| 3 | 24 | | | | | | | | | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-159986, filed Oct. 4, 2022, which is hereby incorporated by reference herein in its entirety.

What is claimed is:

1. A toner comprising a toner particle comprising a binder resin, and a silica fine particle,
wherein the toner particle comprises at least one polyvalent metal element selected from the group consisting of aluminum, iron, zinc, magnesium and calcium,
a total content of the polyvalent metal elements in the toner particle, as measured by inductively coupled plasma atomic emission spectroscopy (ICP-AES), is 0.10 to 2.50 μmol/g,
a number-average particle diameter of a primary particle of the silica fine particle is 40 nm to 500 nm, and
in DD/MAS measurement of solid ²⁹Si-NMR of the silica fine particle, peak PD1 corresponding to a silicon atom represented by Si^{a} in a structure represented by formula (1) and peak PD2 corresponding to a silicon atom represented by Si^{b} in a structure represented by formula (2) are observed, and when an area of the peak PD1 is defined as SD1 and an area of the peak PD2 is defined as SD2, the SD1 and the SD2 satisfy:
1.2≤(SD1+SD2)/SD1≤10.0 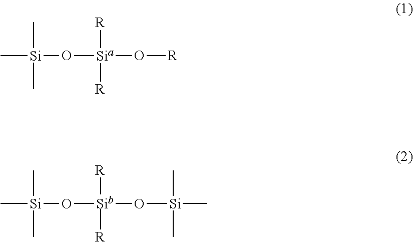
in the formula, R independently represents a hydrogen atom, a methyl group or an ethyl group.

2. The toner according to claim 1,
wherein, when a peak PQ corresponding to a silicon atom represented by Si^{e} in a structure represented by formula (3) is observed in the DD/MAS measurement of solid-state ²⁹Si-NMR of the silica fine particle and an area of the peak PQ is defined as SQ, the SD1, the SD2 and the SQ satisfy:
1.2≤(SD1+SD2)/SD1≤10.0

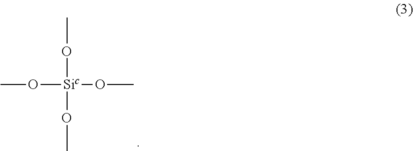

3. The toner according to claim 1, wherein the toner particle comprises aluminum in an amount of 0.10 to 0.32 μmol/g as the polyvalent metallic element.

4. The toner according to claim 1, wherein Mw is 25000 to 60,000, and Mw/Mn is 5 to 10, when a weight-average molecular weight is the Mw and a number-average molecular weight is the Mn in the gel-permeation chromatography measurement of the tetrahydrofuran-soluble component of the toner.

5. The toner according to claim 1, wherein a content of the silica line particle is 0.01 to 10.0 parts by mass with respect to 100 parts by mass of the toner particle.

6. The toner according to claim 1, wherein the toner contains a monovalent metal and the monovalent metal is at least one metal selected from the group consisting of Na, Li and K.

7. The toner according to claim 6, wherein a content of the monovalent metal is 50 to 90 mass % with respect to a total content of the polyvalent metal and the monovalent metal.
